(19) United States
(12) Patent Application Publication
(10) Pub. No.: US 2011/0051190 A1
(43) Pub. Date: Mar. 3, 2011

(54) INFORMATION PROCESSING APPARATUS, INFORMATION PROCESSING METHOD, AND PROGRAM

(75) Inventor: Koichi Abe, Yokohama-shi (JP)

(73) Assignee: CANON KABUSHIKI KAISHA, Tokyo (JP)

(21) Appl. No.: 12/870,217

(22) Filed: Aug. 27, 2010

(30) Foreign Application Priority Data
Sep. 1, 2009 (JP) 2009-201853
Dec. 16, 2009 (JP) 2009-285354

(51) Int. Cl. G06F 15/00

(52) U.S. Cl. 358/1.15

(57) ABSTRACT

An apparatus includes a management unit configured to manage a device that provides a plurality of functions, and a utilization unit configured to utilize one function among the plurality of functions. In the apparatus, the management unit confirms whether a function different from the one function, among the plurality of functions, is available according to management and control data that includes information for constructing a management screen, which management screen being a screen configured to manage the device, and a setting unit sets an argument to an object indicating a link to the utilization unit according to a result of the confirmation. In the apparatus, the utilization unit is configured, if the object, which is displayed on the management screen, is designated, to set the device according to the argument.

### BACKGROUND OF THE INVENTION

1. Field of the Invention

The present invention relates to an information processing apparatus, an information processing method, and a program.

2. Description of the Related Art

In recent years, a system including an information processing apparatus and a peripheral apparatus connected thereto via an interface, such as universal serial bus (USB), Ethernet®, or wireless local area network (LAN), in which the peripheral apparatus is controlled by the system, has been widely and effectively used in environments such as home or offices. More specifically, a printer, a copying machine, a facsimile apparatus, a scanner, or a digital camera and an apparatus having a combination of functions of the above-described apparatuses and machines are used as a peripheral apparatus.

To Windows® 7 of Microsoft Corporation, anew function for managing a peripheral apparatus connected to an information processing apparatus, such as a personal computer (PC), has been introduced. More specifically, Device Stage® function, which includes a Devices and Printers folder, which is a window for displaying an apparatus connected to the PC, and a function for linking to an application or a service uniquely provided to each peripheral apparatus, has been introduced to Windows® 7.

A screen of the Devices and Printers folder, which is illustrated in FIG. 5A, can be displayed by an operation from the “start menu” of Windows 7®. Furthermore, a Device Stage screen (FIG. 5B), which displays information about the status of each peripheral apparatus, can be displayed by an operation via the Devices and Printers folder. The Device Stage screen can provide a visually useful screen. Via the Device Stage screen, a user is allowed to readily utilize and access a function and a service related to the apparatus. If a scanner is used as a peripheral apparatus, a link to an application capable of reading an image and an image of a document can be provided on the Device Stage screen. In this case, by launching and utilizing the application capable of reading an image and an image of a document, an image or a document image can be read by using the peripheral apparatus (scanner).

Meanwhile, with the widespread use of the Internet, various types of online services have been provided, which include an information processing apparatus and a peripheral apparatus connected to the Internet and execute data communication via the Internet. More specifically, a conventional online service utilizes the Device Stage screen including a link to a customer support page of a web site of a manufacturer who provides the online service, which is provided on the Internet. By utilizing the online service like this, a user can easily access a web site provided related to the apparatus. In the following description, the Device Stage screen may also be referred to as a “device management screen”.

A conventional system includes a multifunction printer (peripheral) (MFP), which has a plurality of functions such as a printer function, a facsimile transmission function, a scanner function, and a storage function. Conventionally, if a user desires to read an image or a document image by utilizing the scanner function of an MFP from an application, the user generally executes the following operations. More specifically, the user:

(1-1) launches the application,

(1-2) selects a scanner (driver), which is an input device, via a scanner selection portion provided to the application, and

(1-3) executes reading by using the application.

Suppose that a plurality of input devices, such as an MFP or a scanner, is connected to one PC and that drivers for the input devices have already been installed on the PC. In this case, after image reading processing is executed at least once, an input device that has been selected last is often selected as a default device to be used when the application is launched the next time. Japanese Patent Application Laid-Open No. 85132 discusses the above-described conventional method.

When an image of a document set on an MFP is read by using an application linked on the Device Stage screen, processing executed therefor is different from that in a conventional method. To paraphrase this, because the Device Stage screen is displayed via the Devices and Printers folder, the following operations are to be executed. More specifically, the user:

(2-1) opens the Devices and Printers folder,

(2-2) selects a peripheral apparatus to be operated within the Devices and Printers folder,

(2-3) opens the Device Stage screen for the peripheral apparatus,

(2-4) launches the application via the Device Stage screen, and

(2-5) executes reading by using the application.

Suppose that a plurality of input devices, such as an MFP or a scanner, is connected to one PC and that drivers for the input devices have already been installed on the PC. In addition, suppose that image reading processing has been executed at least once, from the application, by using a specific scanner. In this state, the scanner is selected as a default device to be used when the application is launched the next time.

In this state, by using an MFP different from the scanner and by executing the operations (2-1) through (2-5), suppose that processing is further executed for reading an image of a document set on the MFP. If the image reading processing is executed from the application in the operation (2-5), then the application executes document image reading processing by using the scanner that has been set as the default device in the application, instead of using the MFP. As a result, the image or the document image desired by the user cannot be read and the image reading processing may fail.

Suppose that an MFP is connected to one PC via a plurality of interfaces, such as USB or an Ethernet network. In this case, the driver of the MFP may vary (i.e., the name of the driver of the MFP may vary) according to the interface used for the connection. More specifically, if a TWAIN driver connected via USB is used as illustrated in FIG. 6B, a driver name “ABC Kmmn (TWAIN)” is displayed in a scanner selection field of the application. On the other hand, if a TWAIN driver connected via a network by using an independent hardware vendor (IHV) native protocol is used, a driver name “ABC Kmmn (TWAIN) Network” is displayed in a scanner selection field of the application.

Furthermore, suppose that an MFP is connected to one PC via two interfaces, i.e., via USB and an Ethernet network. In this case, the user selects a USB-connected TWAIN driver “ABC Kmmn (TWAIN)” via a scanner selection field of the application by executing the operation (1-2) of the operation of a conventional method. Then, the user performs the operation (2-3) to executing reading by the MFP from the application via USB connection. When the reading is completed, in the application, the USB-connected TWAIN driver “ABC Kmmn (TWAIN)” is selected as a default device used when the application is launched the next time.

Moreover, suppose, in this state, that a USB cable used for the USB connection is taken off from the MFP to cause the MFP to be connected to the PC via the Ethernet network only. Suppose further that an application linked with the Device Stage screen is launched in this state and that the user executes reading by the MFP via the Ethernet network by using a TWAIN driver “ABC Kmmn (TWAIN) Network”, which is connected via a network by using an IHV native protocol. In this case, if the reading is executed from the application by executing the operation (2-5), the application executes the following operations.

More specifically, the application uses the TWAIN driver “ABC Kmmn (TWAIN)”, which is connected via USB and set as the default device within the application, to execute image reading (document image reading) processing. In other words, the application does not use the TWAIN driver “ABC Kmmn (TWAIN) Network” connected via the network by using the IHV native protocol in this case.

More specifically, the application performs not use the TWAIN driver “ABC Kmmn (TWAIN) Network” of the network the connection of the IHV native protocol.

As a result, an image (document image) desired by the user to be read cannot be read because the MFP is connected to the PC not via USB. Accordingly, in this case, the image (document image) reading processing may fail.

### SUMMARY OF THE INVENTION

According to an aspect of the present invention, an apparatus includes a management unit configured to manage a device that provides a plurality of functions, and a utilization unit configured to utilize one function among the plurality of functions. In the apparatus, the management unit is configured to confirm whether a function different from the one function, among the plurality of functions, is available according to management and control data that includes information for constructing a management screen, which manages the device and configured to set an argument to an object indicating a link to the utilization unit according to a result of the confirmation. In addition, in the apparatus, the utilization unit is configured, if the object, which is displayed on the management screen, is designated, to set the device according to the argument.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary system configuration of a peripheral apparatus control system including an information processing apparatus and a peripheral apparatus.

FIGS. 2A and 2B illustrate an exemplary hardware configuration of a PC and an MFP.

FIG. 3 illustrates an exemplary software configuration of the PC.

FIG. 4 illustrates an exemplary configuration of a printer driver of the PC.

FIGS. 5A and 5B illustrate an example of a Devices and Printers folder and a device management screen.

FIGS. 6A through 6D illustrate an example of a Windows Image Acquisition (WIA) application and a TWAIN application.

FIGS. 7A and 7B illustrate an exemplary software configuration of the PC.

FIG. 8 illustrates an example of a content of a device management and control file.

FIG. 9 illustrates an example of a content of a device management and control file.

FIG. 10 illustrates an exemplary software configuration of a device management application and a TWAIN application.

FIG. 11 is a flow chart illustrating an example of processing executed when a device is connected.

FIG. 12 is a flow chart illustrating an example of processing for installing a device management and control file.

FIG. 13 is a flow chart illustrating an example of processing for launching a device management screen.

FIG. 14 is a flow chart illustrating an example of processing for constructing a content to be displayed on a device management screen.

FIG. 15 is a flow chart illustrating an example of processing for launching a TWAIN application.

FIGS. 16A and 16B illustrate an example of a device management screen and a manual therefor.

FIG. 17 illustrates an example of a content of a device management and control file.

FIG. 18 illustrates an example of a content of a device management and control file.

FIG. 19 is a flow chart illustrating an example of processing for constructing a content to be displayed on the device management screen.

FIG. 20 illustrates an example of a content of a device management and control file.

FIG. 21 illustrates an example of a network utility.

FIG. 22 is a flow chart illustrating an example of processing executed by using the network utility.

FIG. 23 is a flow chart illustrating an example of processing for polling a device N.

FIG. 24 is a flow chart illustrating an example of processing for constructing a content to be displayed on the device management screen.

FIG. 25 is a flow chart illustrating an example of processing for launching a TWAIN application.

### DESCRIPTION OF THE EMBODIMENTS

Various exemplary embodiments, features, and aspects of the invention will be described in detail below with reference to the drawings.

Note that information about the Windows 7 operating system (OS) mentioned here but not described in detail is released on a web page of Microsoft Corporation under the following URL as of Jul. 22, 2009:

http://msdn.microsoft.com/en-us/library/default.aspx Accordingly, such information will not be described in detail here.

In addition, in the following description, a term “USB” refers to a universal serial bus. Detailed information about USB is released in a web site under the following URL as of Jul. 22, 2009:

http://www.usb.org/home Accordingly, “USB” will not be described in detail here.

Furthermore, a term “WSD” is an abbreviation of “web service on devices”. Detailed information about WSD is released in the web site of Microsoft Corporation under the following URL as of Jul. 22, 2009: http://www.microsoft.com/whdc/connect/rally/rallywsd.mspx Accordingly, “WSD” will not be described in detail here.

In addition, in the following description, a term “WIA” is an abbreviation of “Windows Image Acquisition”. WIA is an application program interface (API), which is a standard interface for inputting an image on a Windows® OS from an image scanner. Accordingly, “WIA” will not be described in detail here.

Moreover, a term “TWAIN” refers to an interface between a PC, a scanner, and a digital camera, which are managed as a TWAIN Working Group apparatus. Detailed information about TWAIN is released in a web site under the following URL as of Jul. 22, 2009:

http://www.twain.org/ Accordingly, “TWAIN” will not be described in detail here.

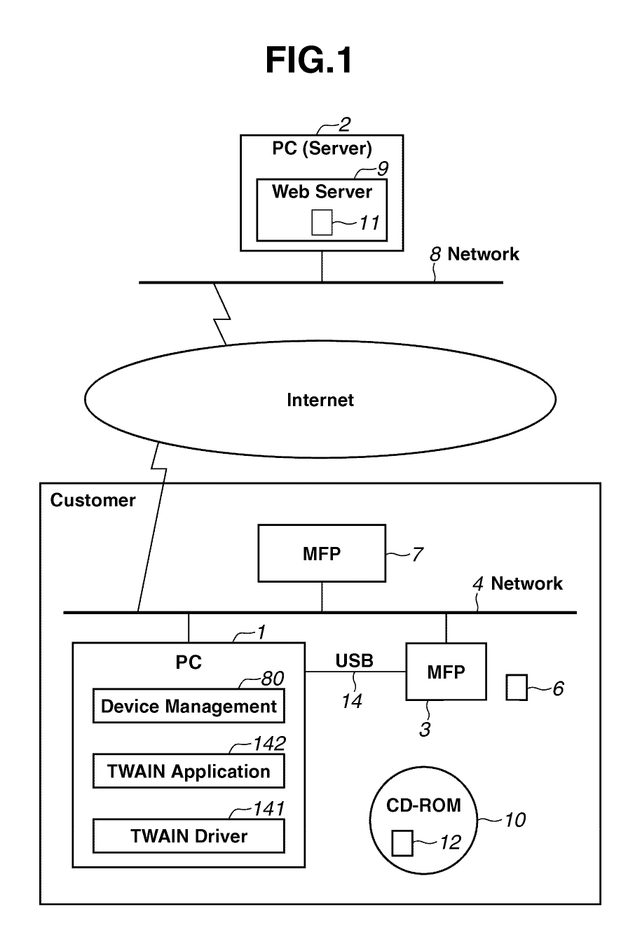

A first exemplary embodiment of the present invention will now be described below. FIG. 1 illustrates an exemplary system configuration of a peripheral apparatus control system including an information processing apparatus and a peripheral apparatus.

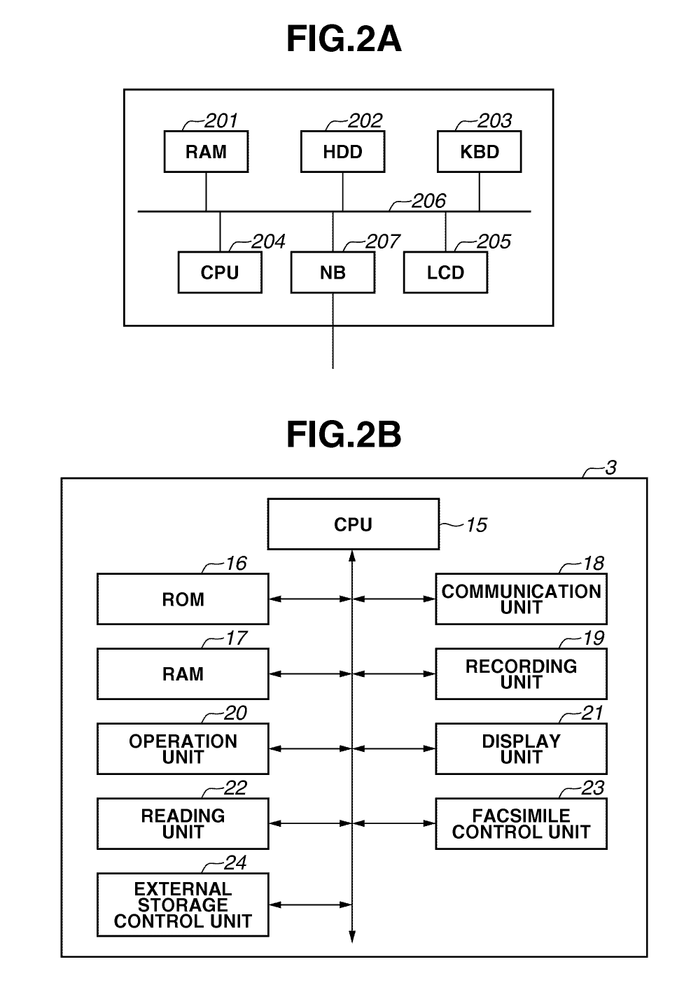

Referring to FIG. 1, information processing apparatuses 1 and 2 are general-purpose PCs. The PCs 1 and 2 includes hardware illustrated in FIG. 2A. In the present invention, it is supposed that an OS equivalent to Windows® 7 has been installed on the PCs 1 and 2.

In the example illustrated in FIG. 1, the PC 1 is connected to a network 4 while the PC 2 is connected to a network 8. Each of the networks 4 and 8 is an Ethernet® network. A multifunction printer (hereinafter may also be simply referred to as an “MFP”) 3 includes a color inkjet printer, a color facsimile apparatus, a color scanner, and an external storage device for flash memory. The MFP 3 is an example of a peripheral apparatus according to the present exemplary embodiment. The MFP 3 is an MFP manufactured by ABC Corporation having a model name “Kmmn”. It is useful if a printer, a copying machine, a facsimile apparatus, a scanner, and a digital camera and an apparatus having a combination of functions of the above-described apparatuses (i.e., a multifunction apparatus) are used as the peripheral apparatus of the present invention.

The MFP 3 includes hardware that will be described in detail below with reference to FIG. 2B. The MFP 3 is connected with the PC 1 via a USB interface 14 and the network 4. Thus, the MFP 3 and the PC 1 are in interactive communication with each other.

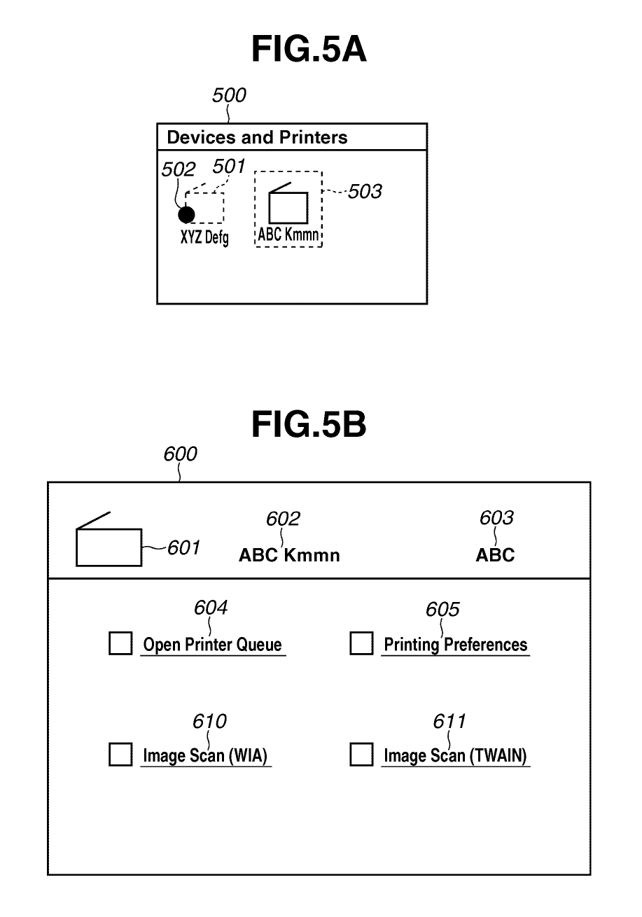

An application 80 includes a file having a “.exe” format (i.e., a file having an extension “.exe”) of Windows. The application 80 is an example of an application of the present invention. The application 80 includes a function for displaying a device management screen illustrated in FIG. 5B.

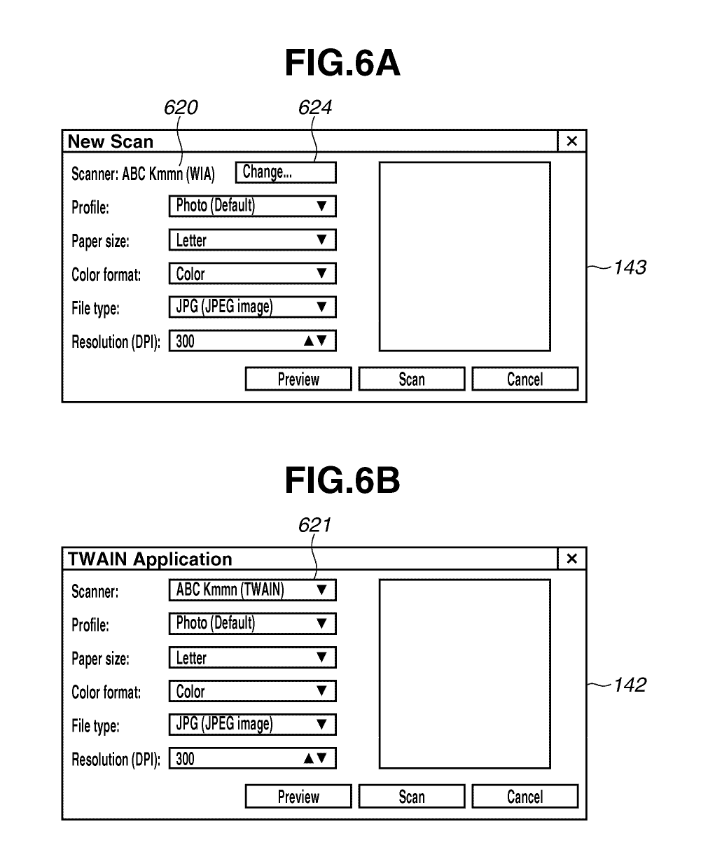

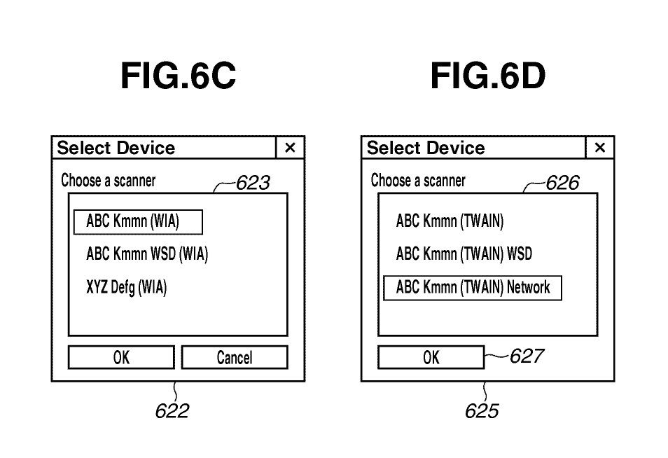

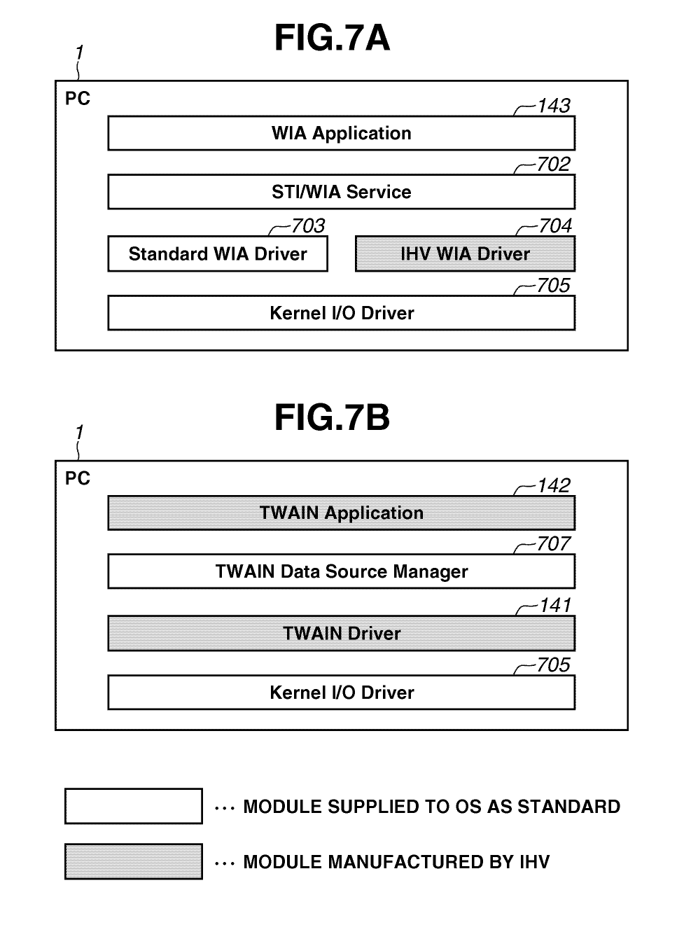

In addition, the PC 1 includes an application compliant with the TWAIN interface. The TWAIN application 142 will be described in detail below with reference to FIG. 6B. Furthermore, the PC 1 includes a TWAIN driver 141, which will be described in detail below with reference to FIG. 7B. The network 4 is a home network for home consumer use, which is constructed in a house of a user (customer) of the MFP 3. The MFP 3 is an MFP commonly used among the family of the user, which is connected to the PC 1 via the network 4 within the user's house.

The network 8 is an office network constructed within ABC Corporation. The PC 2, which is connected to the network 8, includes a web server 9. The web server 9 includes a function of a general web server. The web server 9 provides a web site of ABC Corporation via the Internet.

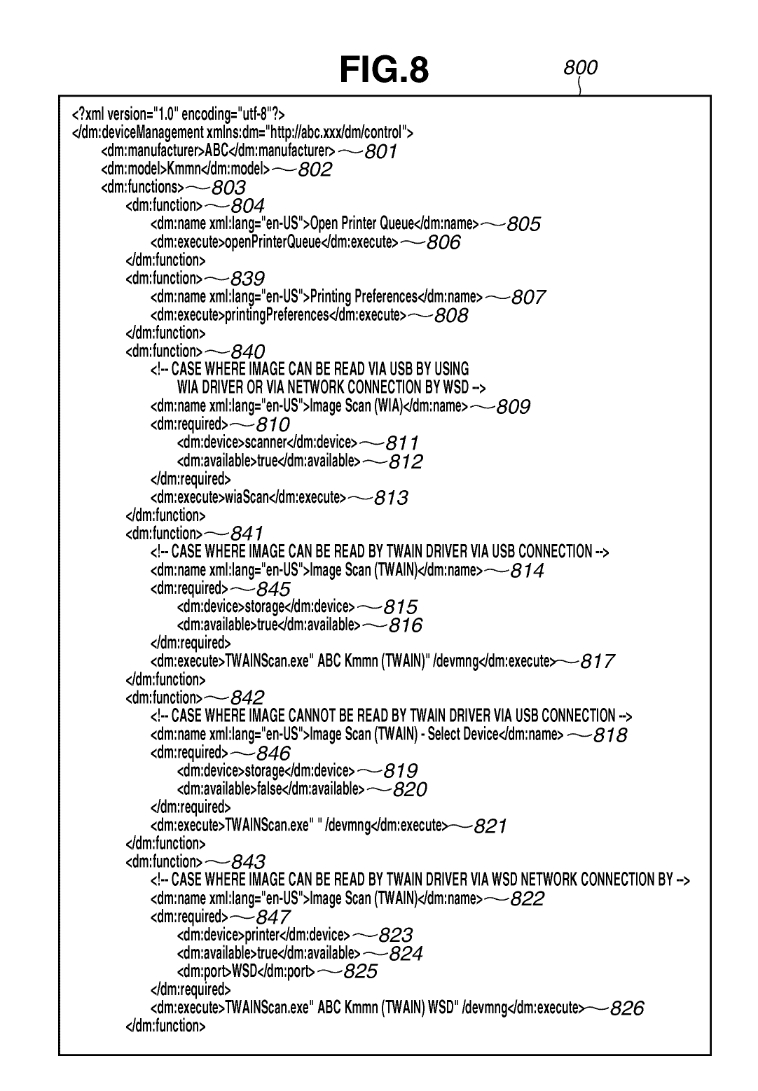

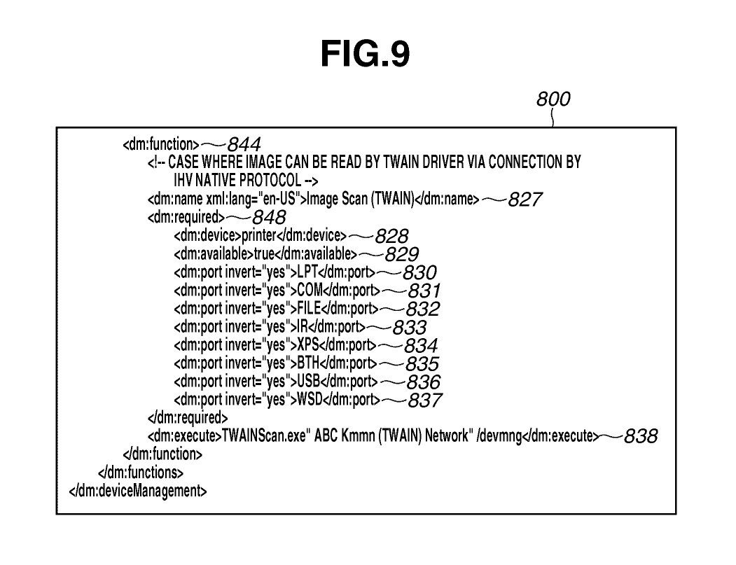

A compact disc-read only memory (CD-ROM) 10 can be mounted on the PC 1. The CD-ROM 10 stores software (a program) and an electronic file. The web server 9 includes a file storage portion 11 while the CD-ROM 10 includes a file storage portion 12. A device management and control file 800, which will be described in detail below with reference to FIGS. 8 and 9, is stored in the file storage portions 11 and 12 of the web server 9 and the CD-ROM 10. The device management and control file 800 is loaded and transmitted from the file storage portions 11 and 12. The device management and control file 800 is an example of device management and control data.

An analog telephone line 5 is used by the PC 1 for transmitting and receiving a facsimile document via MFP 3. A flash memory 6 can be mounted into a flash memory insertion slot (not illustrated) of the MFP 3. The flash memory 6 can be referred to from the PC 1 as a storage device. An MFP 7 is an MFP different from the MFP 3. The MFP 7 is manufactured by XYZ Corporation having a model name “Defg”.

FIGS. 2A and 2B illustrate an exemplary hardware configuration of the PC and the MFP according to the present exemplary embodiment. The PCs 1 and 2 include hardware illustrated in FIG. 2A. In the present exemplary embodiment, the hardware configuration of the PC 1 will be described with reference to FIG. 2A, representing the hardware configuration of the PCs 1 and 2.

Referring to FIG. 2A, the PC 1 includes a random access memory (RAM) unit (hereinafter simply referred to as a “RAM”) 201, a hard disk drive (HDD) 202, a keyboard (KBD) 203, and a central processing unit (CPU) 204. In addition, the PC 1 includes a display (a liquid crystal display (LCD) 205 and a network board (NB) 207. Furthermore, the PC 1 includes a bus 206. The RAM 201, the HDD 202, the KBD 203, the CPU 204, the LCD 205, and the NB 207 are in communication with one another via the bus 206.

The HDD 202 is an example of a storage unit. The KBD 203 is an example of an input unit. The CPU 204 is an example of a control unit. The LCD 205 is an example of a display unit. The NB 207 is an example of a communication control unit. A USB port of the USB interface 14 use is included in the NB 207. It is also useful if a portable CD-ROM or a built-in read-only memory (ROM) is used as the storage unit.

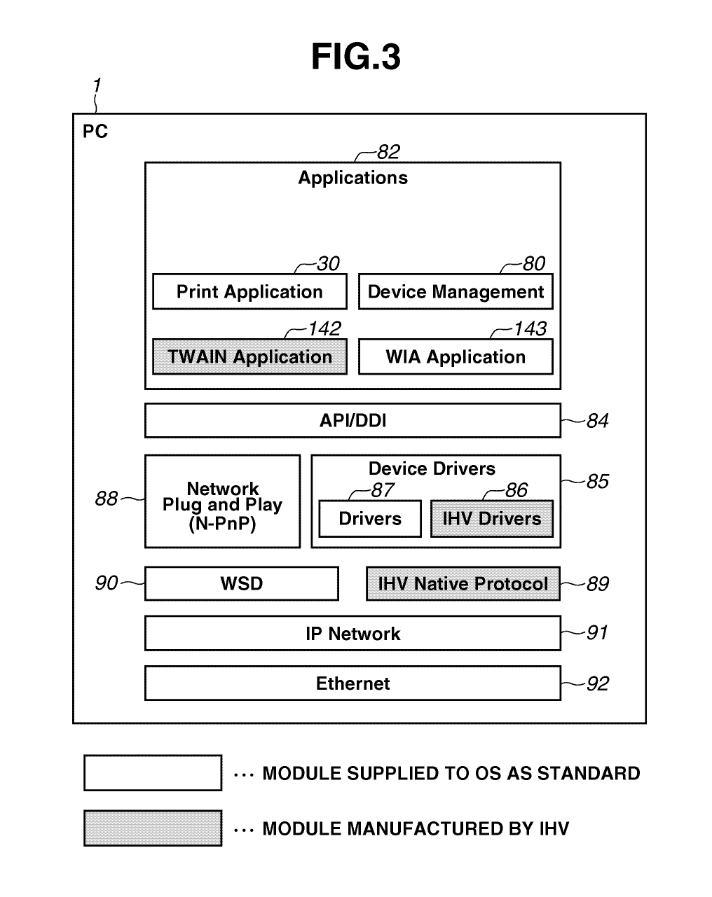

An application, such as the device management application 80 or the TWAIN application 142, and each module (software) illustrated in FIGS. 3, 4, 7, and 10 are stored on the HDD 202 and are loaded and executed by the CPU 204 on the RAM 201 where necessary. Thus, the CPU 204 implements a function of the application, such as the device management application 80 or the TWAIN application 142, and each module (software) illustrated in FIGS. 3, 4, 7, and 10. The TWAIN application 142 is an example of a utilization unit. The MFP 3 has the hardware configuration illustrated in FIG. 2B.

In the example illustrated in FIG. 2B, a CPU 15 includes a microprocessor. The CPU 15, which functions as a central processing unit of the MFP 3, controls a RAM 17, a communication unit 18, a recording unit 19, an operation unit 20, a display unit 21, a reading unit 22, a facsimile control unit 23, and an external storage control unit 24 according to a program stored on a ROM 16.

The ROM 16 stores a program used by the MFP 3 for executing recording (printing) and a program used by the MFP 3 for executing processing for notifying information about the status of print processing to the PC 1 under control of a printer driver 50. In addition, the ROM 16 stores a program used by the MFP 3 for transmitting and receiving a facsimile document under control of a FAX driver (not illustrated). Furthermore, the ROM 16 stores a program used by the MFP 3 for notifying the status of transmission or reception of facsimile documents to the PC 1 under control of the FAX driver (not illustrated). Moreover, the ROM 16 stores a program used by the MFP 3 for executing image reading processing under control of a WIA driver 704 (FIG. 7A) or the TWAIN driver 141. In addition, the ROM 16 stores a program used by the MFP 3 for notifying the status of image reading operations to the PC 1 under control of the WIA driver 704 (FIG. 7A) and the TWAIN driver 141.

The RAM 17 temporarily and primarily stores print data, which is transmitted from the PC 1 and based on which an image is to be printed by the recording unit 19. In addition, the RAM. 17 temporarily stores various data, such as image data read by the reading unit 22, data to be transmitted by facsimile, which has been transmitted from the PC 1, and data received by facsimile control unit 23 as facsimile data.

The communication unit 18 includes the USB interface 14, a connection port for connection via the network 4, and a connection port for connection via the analog telephone line 5. The communication unit 18 controls analog communication via facsimile. The recording unit 19 includes a recording unit and an electric circuit. The recording unit of the recording unit 19 includes an inkjet type recording head, each color ink, a carriage, and a recording paper conveyance mechanism. The electric circuit of the recording unit 19 includes an application specific integrated circuit (ASIC), which is used for generating a printing pulse at the recording head based on the print data.

By executing a printing operation by using an application capable of executing printing or by executing a facsimile transmission operation, a content to be displayed (image data) of a file opened by the application is temporarily stored on the HDD 202 of the PC 1 as a spool file of the Enhanced Metafile (EMF) format. The spool file is then converted by the printer driver 50 or the FAX driver into print data or into facsimile transmission data including a command for controlling the MFP 3. Furthermore, the print data or the facsimile transmission data is then transmitted to the MFP 3 via the USB interface 14 or the network 4.

The print data received by the MFP 3 is converted by the recording unit 19 into a printing pulse and then is printed on a recording paper based on the printing pulse. On the other hand, the facsimile transmission data received by the MFP 3 is converted by facsimile control unit 23 into a facsimile communication protocol and then is transmitted to a communication destination facsimile machine via the analog telephone line 5.

The operation unit 20 includes various buttons, such as a power button or a reset button. The user can execute a job by using the MFP 3 by operating the operation unit 20. The display unit 21 includes a touch panel, which includes an LCD. The display unit 21 can display the status of the MFP 3. Furthermore, the user can execute various settings via the display unit 21. In addition, the user can enter, display, and confirm various settings and the telephone number of a communication destination facsimile apparatus.

The reading unit 22 includes a color image sensor and an electric circuit including an image processing ASIC. The reading unit 22 controls the scanner function. Facsimile control unit 23 includes a FAX modem and an analog communication circuit. Facsimile control unit 23 controls transmission and receipt of a facsimile document according to the facsimile communication protocol.

The external storage control unit 24 includes a flash memory mounting slot and an interface circuit for storage device. The external storage control unit 24 controls a flash memory mounted on the MFP 3.

FIG. 3 illustrates an exemplary software configuration of the PC. Referring to FIG. 3, the PC 1 includes an Ethernet control stack 92, an Internet protocol (IP) network control stack 91, a WSD control stack 90, an IHV native protocol control stack 89, and an N-PnP control stack 88. The Ethernet control stack 92 controls Ethernet. The IP network control stack 91 controls an IP network. The WSD control stack 90 controls WSD. The IHV native protocol control stack 89 controls an IHV-unique protocol. The N-PnP control stack 88 controls Network Plug and Play (hereinafter simply referred to as “N-PnP”).

Meanwhile, a standard function of Windows® 7 OS “Plug and Play Extensions (PnP-X)” has been presented as one of Plug and Play Extension functions for supporting network-connected devices. However, N-PnP is used in the present exemplary embodiment as a function equivalent to PnP-X.

Device drivers 85 includes standard drivers 87, which are included in the OS as standards, and IHV-manufactured drivers 86, which are provided by IHVs. An application/device driver interface (DDI) interface 84 includes an application programming interface (API) and a DDI. A device management application 80 is included in the OS as standard.

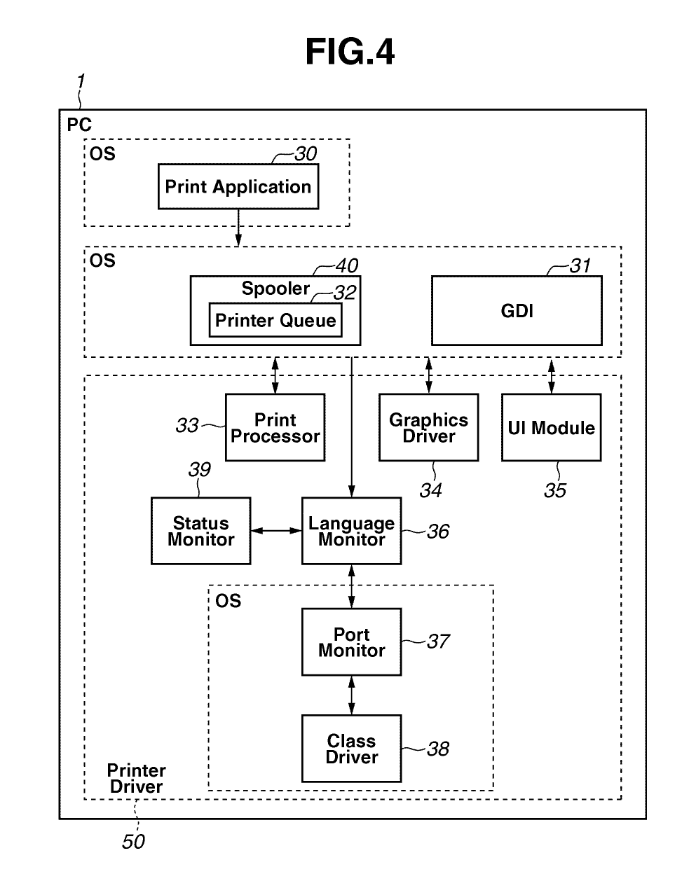

A print application 30 is an application capable of executing printing, which will be described in detail below with reference to FIG. 4. The TWAIN application 142 complies with the TWAIN interface. A WIA application 143 complies with the WIA interface, which will be described in detail later below with reference to FIG. 6A.

Applications 82 includes the device management application 80 and the applications 30, 142, and 143. The device management application 80 is capable of managing, executing, and displaying a Device and Printers folder 500 (FIG. 5A) and a device management screen 600 (FIG. 5B) via the application/DDI interface 84. In the following description, the Device and Printers folder 500 will be simply referred to as a “folder” 500.

FIG. 4 illustrates an example of a printer driver included in the PC. Referring to FIG. 4, the printer driver 50 is a printer driver for the MFP 3, which is installed on the PC 1. The printer driver 50 includes a plurality of modules 33 through 36 and 39. The application (print application) 30, which is capable of executing printing, is equivalent to “Notepad” (Notepad.exe), which is a text editor included in the OS as standard.

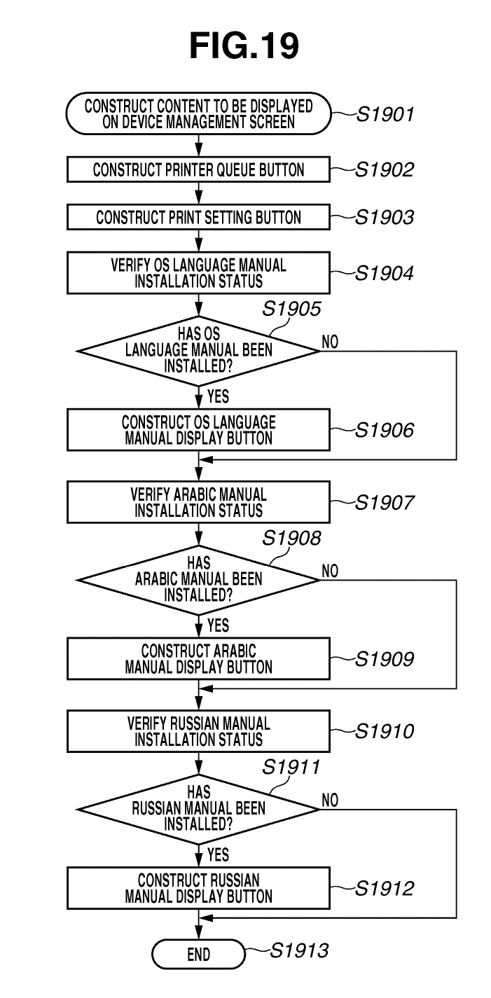

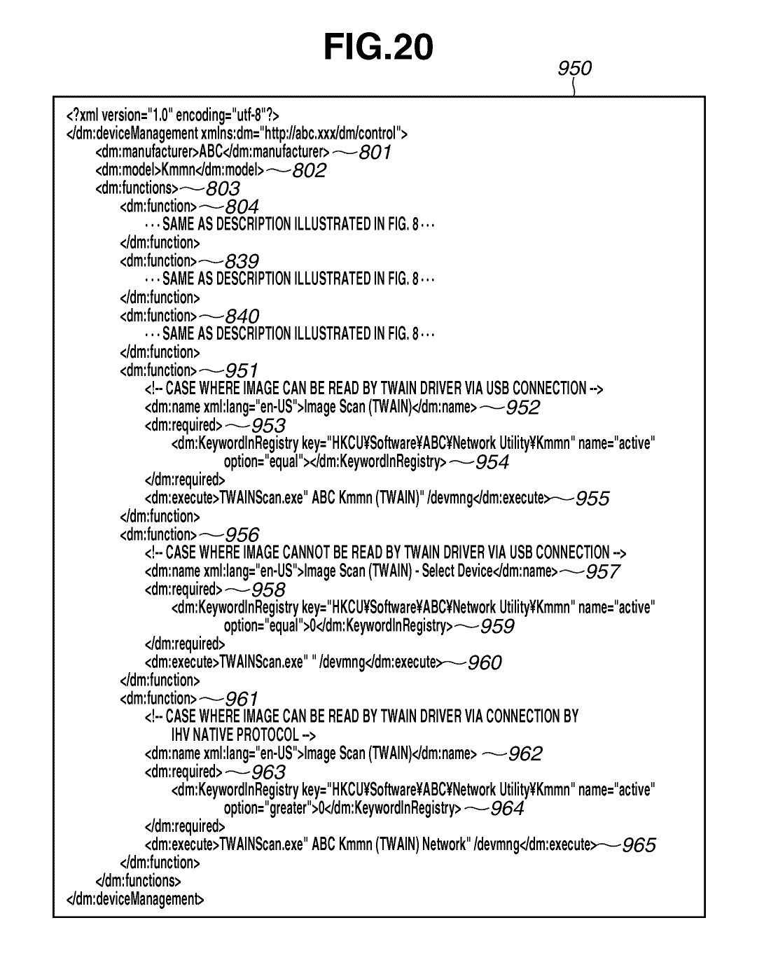

A graphics device interface (GDI) 31 constitute apart of the OS. A printer queue 32 is included in the spooler 40 as a part thereof. The printer queue 32 queues a print job. A queued print job is displayed in a printer queue folder 107 (FIG. 19).

A print processor 33 changes a print layout and executes special processing on an image to be printed. A graphics driver 34, which is a core component of the printer driver for image processing, executes image processing for printing according to a drawing command from the GDI 31 and generates a print control command.

A user interface (UI) module 35 provides and controls a UI of the printer driver. A language monitor 36 is a data communication interface (I/F) configured to control transmission and receipt of data. A status monitor 39 displays information about a status of the MFP 3, such as the ink remaining amount, an issued warning, and error events.

A port monitor 37 transmits data received from the language monitor 36 to an appropriate port. In addition, the port monitor 37 receives data transmitted from the MFP 3 via a class driver 38. The class driver 38 is a low level module provided closest to a port. In the present exemplary embodiment, the class driver 38 is equivalent to a WSD- or IHV-unique protocol printer class driver. The class driver 38 controls a port (in the present exemplary embodiment, a USB port or a network port). The printer driver 50 is manufactured by ABC Corporation, which is the manufacturer of the MFP 3.

FIG. 5 illustrates an example of a Devices and Printers folder and a device management screen. Referring to FIG. 5A, the Devices and Printers folder 500 is displayed on the PC 1. Furthermore, a printer and a FAX machine that can be utilized from the PC 1 for each driver are displayed in the Devices and Printers folder 500. In the present exemplary embodiment, a device 501, whose name is “XYZ Defg”, and a device 503, whose name is “ABC Kmmn”, are displayed in the Devices and Printers folder 500 as available devices.

A default mark 502 indicates a default device of the system. In the present exemplary embodiment, the device 501 has been set as the default device. In the folder 500, a device icon of the device 501 is illustrated with dotted lines. This indicates that the device 501 is not currently available. On the other hand, a device icon of the device 503 is illustrated with solid lines. This indicates that the device 503 is currently available.

Referring to FIG. 5B, when the device 503 of the Devices and Printers folder 500 (FIG. 5A) is selected by the user, the device management screen 600 is launched and displayed. The MFP 3 can be managed via the device management screen 600. In the upper field of the device management screen 600, a device icon 601, a device name 602, and manufacturer information 603 are displayed.

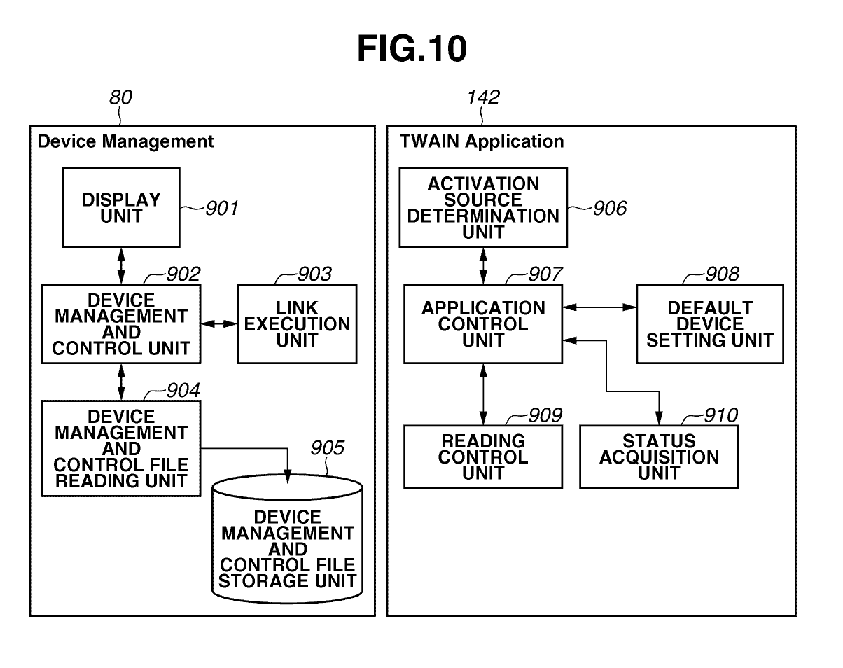

Data of the device icon 601 is stored in apart (area) (not illustrated) of a device management and control file storage unit 905 (FIG. 10). The device name 602 displays the device name of the device 503 displayed in the folder 500. The manufacturer information 603 displays a text string designated in an element <dm:manufacturer> 801 (FIG. 8).

On the other hand, in the lower field of the device management screen 600, a link to each function associated with the device 503 is displayed. More specifically, a printer queue button 604, a print setting button 605, an image reading (WIA) button 610, and an image reading (TWAIN) button 611 are displayed. In the following description, the image reading (WIA) button 610 will also be simply referred to as the “reading (WIA) button 610” while the image reading (TWAIN) button 611 will also be simply referred to as the “reading (TWAIN) button 611”. The image reading (TWAIN) button 611 is an example of an object.

In an element <dm:functions>803 (FIGS. 8 and 9), elements <dm:function> 804, 839 through 844, each of which describing each corresponding button and function, are described. For the image reading (TWAIN) button 611, arguments are set when the TWAIN application 142 is launched may vary according to the status of connection between the PC 1 and the MFP 3.

FIGS. 6A through 6C illustrate an example of a WIA application and a TWAIN application. Referring to FIG. 6A, the WIA application 143 is included in the OS as standard. More specifically, the WIA application 143 is software that operates in interlock with a WIA driver, such as a WIA driver 703 or 704 (FIG. 7A). Furthermore, the WIA application 143 is software capable of reading an image by using the scanner of the MFP 3.

A scanner selection field 620 is a scanner for reading an image. The user can select a WIA driver installed on the PC 1 via the scanner selection field 620. In the example illustrated in FIG. 6A, the WIA driver “ABC Kmmn (WIA)” has been selected. The user can select a scanner (driver) via a scanner selection dialog 622 (FIG. 6C). The scanner selection dialog 622 is displayed when the user presses a scanner change button 624.

FIG. 6C illustrates an example of the scanner selection dialog 622. Referring to FIG. 6C, the scanner selection dialog 622 includes a scanner selection field 623. The scanner selection field 623 displays the WIA driver installed on the PC 1. By selecting a WIA driver, the user can designate a scanner (driver) to be used for reading an image by using the WIA application 143.

In the present exemplary embodiment, any of the scanners (drivers) “ABC Kmmn (WIA)”, “ABC Kmmn WSD (WIA)”, and “XYZ Defg (WIA)” can be selected. The scanner (driver) “ABC Kmmn (WIA)” is an alternative for the WIA driver 704, which is allocated to the MFP 3 when the IHV-manufactured WIA driver 704, which is manufactured by the manufacturer of the MFP 3 (in the present exemplary embodiment, ABC Corporation) is installed on the MFP 3, if the MFP 3 is connected to the PC 1 via the USB interface 14.

The scanner (driver) “ABC Kmmn WSD (WIA)” is an alternative for the WIA driver 703, which is allocated to the MFP 3 when the WIA driver 703, which is included in the OS as standard, is installed on the MFP 3 if the MFP 3 is connected to the PC 1 via the network 4 by using WSD. On the other hand, the scanner (driver) “XYZ Defg (WIA)” is an alternative for the WIA driver 703, which is allocated to the MFP 7 when the WIA driver 703, which is included in the OS as standard, is installed on the MFP 7 if the MFP 7 is connected to the PC 1 via the network 4 by using WSD. In the example illustrated in FIG. 6C, the scanner (driver) “ABC Kmmn (WIA)” has been selected.

In the example illustrated in FIG. 6B, the TWAIN application 142 is a TWAIN application manufactured by ABC Corporation. More specifically, the TWAIN application 142 is software that operates in interlock with a TWAIN driver, such as the TWAIN driver 141 (FIG. 7B). Furthermore, the TWAIN application 142 is software capable of reading an image by using the scanner of the MFP 3.

Via a scanner selection field 621, the user can select the TWAIN driver that has been installed on the PC 1 as the scanner (driver) for reading an image. For the scanner for reading an image, the user can select any from among the scanners “ABC Kmmn (TWAIN)”, “ABC Kmmn (TWAIN) WSD”, and “ABC Kmmn (TWAIN) Network”. The scanner (driver) “ABC Kmmn (TWAIN)” is an alternative for the TWAIN driver 141, which is allocated to the MFP 3 when the TWAIN driver 141, which is manufactured by the manufacturer of the MFP 3 (in the present exemplary embodiment, ABC Corporation) is installed on the MFP 3, if the MFP 3 is connected to the PC 1 via the USB interface 14.

The scanner (driver) “ABC Kmmn (TWAIN) WSD” is an alternative for the TWAIN driver 141, which is allocated to the MFP 3 when the TWAIN driver 141 is installed on the MFP 3 if the MFP 3 is connected to the PC 1 via the network 4 by using WSD. On the other hand, the scanner (driver) “ABC Kmmn (TWAIN) Network” is an alternative for the TWAIN driver 141, which is allocated to the MFP 3 when the TWAIN driver 141 is installed on the MFP 3 if the MFP 3 is connected to the PC 1 via the network 4 by using the IHV native protocol. In the example illustrated in FIG. 6B, the scanner (driver) “ABC Kmmn (TWAIN)” has been selected.

FIG. 6D illustrates an exemplary scanner selection dialog. Referring to FIG. 6D, a scanner selection dialog 625 is displayed by the TWAIN application 142. TWAIN drivers installed on the PC 1 is displayed in a scanner selection field 626. The user can designate a scanner (driver) used for reading an image by using the TWAIN application 142 by selecting a TWAIN driver via the scanner selection field 626. More specifically, in the present exemplary embodiment, the user can select a scanner (driver) from among the following scanners (drivers):

ABC Kmmn (TWAIN)

ABC Kmmn (TWAIN) WSD

ABC Kmmn (TWAIN) Network

The above-described TWAIN drivers are the same as those described above in relation to the scanner selection field 621. In the example illustrated in FIG. 6D, the scanner “ABC Kmmn (TWAIN) Network” has been selected. When the user presses an OK button 627, the TWAIN application 142 is launched in a state where the TWAIN driver that has been selected via the scanner selection field 626 is designated. If the name of the TWAIN driver, which is a first argument for launching the TWAIN application 142, has a value “” (“null”) (i.e., if the device is an unknown device), then the TWAIN application 142 displays the scanner selection dialog 625.

The TWAIN application 142 has a function for designating the default scanner (driver) and the application launching source, which are selected when launching the application, according to the following launching arguments:

First argument: TWAIN driver name
Second argument: application launching source

/devmng: used when launching from

device management screen

/other: used when launching from

source other than
device management screen

### [Case 1]

TWAINScan.exe “ABC Kmmn (TWAIN)”/devmng

In Case 1, the TWAIN application 142 is launched from the device management screen 600 and the MFP 3 reads an image by using the TWAIN driver 141 via USB connection.

### [Case 2]

TWAINScan.exe “ABC Kmmn (TWAIN) WSD”/devmng

In Case 2, the TWAIN application 142 is launched from the device management screen 600 and the MFP 3 reads an image by using the TWAIN driver 141 via network by WSD.

### [Case 3]

TWAINScan.exe “ABC Kmmn (TWAIN) Network”/devmng

In Case 3, the TWAIN application 142 is launched from the device management screen 600 and the MFP 3 reads an image by using the TWAIN driver 141 via network connection by the IHV native protocol.

### [Case 4]

TWAINScan.exe “ABC Kmmn (TWAIN)”/other

In Case 4, the TWAIN application 142 is launched from a source other than the device management screen and the MFP 3 reads an image by using the TWAIN driver 141 via USB connection. The only difference point between Cases 1 and 4 is the second argument, which describes the application launching source. By utilizing the second argument, the TWAIN application 142 can toggle the processing executed when and after the launch according to the application launching source. Therefore, the present exemplary embodiment can improve the user operability. By launching the TWAIN application 142 to which the first argument has been added, the user can automatically designate the scanner (driver) for reading an image without executing any particular operation, instead of selecting and designating a scanner (driver) via the scanner selection field 621.

### [Case 5]

TWAINScan.exe “”/devmng

In Case 5, after displaying the scanner selection dialog 625 illustrated in FIG. 6D on the device management screen 600 and after the user has selected a TWAIN driver (the TWAIN driver 141 in the present exemplary embodiment), the TWAIN application 142 is launched and the MFP 3 reads an image by using the TWAIN driver 141, which has been selected by the user.

FIG. 7 illustrates an exemplary software configuration of the PC. Referring to FIGS. 7A and 7B, a kernel input/output (I/O) driver 705 is included in the OS as standard. FIG. 7A illustrates an exemplary software configuration used for reading an image on the MFP 3 by using the WIA application 143.

Referring to FIG. 7A, the WIA application 143 (FIG. 6A) is included in the OS as standard. The standard WIA driver 703 is included in the OS as standard. The IHV WIA driver 704 is a driver manufactured by ABC Corporation. A Still Image Architecture (STI)/WIA service 702 is included in the OS as standard. The STI/WIA service 702 is an interface between the WIA application 143 and the WIA drivers 703 and 704.

FIG. 7B illustrates an exemplary software configuration used for reading an image on the MFP 3 by using the TWAIN application 142. Referring to FIG. 7B, the TWAIN application 142 (FIG. 6) is an application manufactured by ABC Corporation. A TWAIN data source manager 707 is included in the OS as standard. The TWAIN driver 141 is a driver manufactured by ABC Corporation. The TWAIN data source for the MFP 3 is included in the TWAIN driver 141.

FIGS. 8 and 9 illustrate an example of a content of a device management and control file. Referring to FIG. 8, a device management and control file 800 is a file used on an English-based OS. Information illustrated in FIGS. 8 and 9 is stored on the file storage portions 11 and 12.

In the example illustrated in FIG. 8, the name of the manufacturer of the device (the MFP 3), i.e., ABC Corporation, is set to an element <dm:manufacturer> 801. The model name of the device (the MFP 3), i.e., “Kmmn”, is set to an element <dm:model> 802. The above-described information is utilized in installing the device management and control file 800. The device management and control file 800 also includes information used to construct the device management screen 600.

On the device management screen 600, which is launched and displayed when the MFP 3 is connected to the PC 1, in order to display the printer queue button 604 (FIG. 5B), the print setting button 605 (FIG. 5B), the image reading (WIA) button 610 (FIG. 5B), and the image reading (TWAIN) button 611 (FIG. 5B), elements <dm:function> 804, 839 through 841, and 842 through 844, which describe each corresponding button and function, are set in an element <dm:functions> 803.

In an element <dm:name xml:lang=“en-US”>Open Printer Queue</dm:name>805 included in the element <dm:function> 804, a text string “Open Printer Queue” is set, which is displayed on the printer queue button 604. In an element <dm:execute> open Printer Queue</dm:execute> 806, a code “open Printer Queue” is set, which describes a function (program) for displaying a printer queue folder. Although not illustrated in the drawing, the printer queue folder includes a function for displaying the status of a print job.

In an element <dm:name xml:lang=“en-US”>Printing Preferences</dm:name> 807 included in the element <dm:function> 839, a text string “Printing Preferences” is set, which is displayed on the print setting button 605. In an element <dm:execute>printing Preferences</dm:execute> 808, a code “printing Preferences” is set, which describes a function (program) for displaying a print setting dialog. Although not illustrated in the drawing, the “print setting dialog” refers to a print setting screen included in the UI module 35 of the printer driver 50.

In an element <dm:namexml:lang=“en-US”>Image Scan (WIA)</dm:name> 809 included in the element <dm:function> 840, a text string “Image Scan (WIA)” is set, which is displayed on the reading (WIA) button 610. In an element <dm:required> 810, information describing a condition for displaying the image reading (WIA) button 610 is set.

An element <dm:device>scanner</dm:device> 811 describes that the device connected to the PC 1 via the USB interface 14 or the network 4 using WSD includes a scanner function that utilizes the WIA driver 704 or the WIA driver 703. An element <dm:available>true</dm:available> 812 describes that the scanner function that utilizes the WIA driver 704 or the WIA driver 703 is available on the device connected to the PC 1 via the USB interface 14 or the network 4 using WSD. More specifically, the condition described by the element <dm:required> 810 corresponds to a case where an image can be read via network connection using USB or WSD by utilizing the WIA driver 704 or 703.

In an element <dm:execute>wiaScan</dm:execute> 813, a code “wiaScan” is set, which describes a function (program) for launching the WIA application 143. In an element <dm:name xml:lang=“en-US”>Image Scan (TWAIN) </dm:name> 814 included in the element <dm:function> 841, a text string “Image Scan (TWAIN)” is set, which is displayed on the reading (TWAIN) button 611. In an element <dm:required> 845, information describing a condition for displaying the reading (TWAIN) button 611 is set.

An element <dm:device>storage</dm:device> 815 describes that the device connected to the PC 1 via the USB interface 14 includes a storage function. An element <dm:available>true</dm:available> 816 describes that the storage function of the device connected to the PC 1 via the USB interface 14 is available.

In determining whether the scanner function of the device (the MFP 3) connected to the PC 1 is available, the element <dm:required> 810 is generally utilized. However, in utilizing the element <dm:required> 810, the Windows® 7 OS cannot execute auto toggle control. More specifically, the Windows® 7 OS, in the scanner function utilizing the TWAIN driver 141, cannot execute auto toggle control by distinguishing between USB connection and WSD connection and by executing appropriate control according to the type of the connection.

Therefore, an appropriate value compliant with each of the interfaces of the PC 1 and the MFP 3 cannot be set in the element <dm:required> 810 as an argument used for launching the TWAIN application 142. Accordingly, the present exemplary embodiment utilizes the “state where the storage function is available”, which is a function different from and not related to the scanner function. The “state where the storage function is available” is described in the element <dm:required> 845.

In other words, by determining the scanner function by identifying the interface between the PC 1 and the device (the MFP 3) by utilizing the “state where the storage function is available”, the present exemplary embodiment enables appropriate information to be set at the time of launching the TWAIN application 142 as the argument. Thus, the present exemplary embodiment can improve the user operability. As described above, the condition described in the element <dm:required> 845 corresponds to a case where an image can be read via USB connection by using the TWAIN driver.

In an element <dm:execute>TWAINScan.exe “ABC Kmmn (TWAIN)”/devmng</dm:execute> 817, a code “TWAINScan.exe “ABC Kmmn (TWAIN)”/devmng” is set, which describes a function (program) for launching the TWAIN application 142. Thus, when the reading (TWAIN) button 611 is pressed by the user, the TWAIN application 142 is launched in a state in which the scanner “ABC Kmmn (TWAIN)”, which indicates the USB-connected TWAIN driver 141, has been set as the default scanner (driver). Accordingly, the present exemplary embodiment can achieve a high user operability.

In an element <dm:name xml:lang=“en-US”>Image Scan (TWAIN) </dm:name> 818 included in the element <dm:function> 842, a text string “Image Scan (TWAIN)—Select Device” is set, which is displayed on the reading (TWAIN) button 611. Because the text string set to the element <dm:name> is used as the text string displayed on the reading (TWAIN) button 611, the text string displayed on the reading (TWAIN) button 611 may be different from the text string illustrated in FIG. 5B. Information describing a condition for displaying the reading (TWAIN) button 611 is set in an element <dm:required> 846. An element <dm:device>storage</dm:device> 819 describes that the device connected to the PC 1 via the USB interface 14 includes the storage function.

An element <dm:available>false</dm:available> 820 describes that the storage function of the device connected to the PC 1 via the USB interface 14 is not currently available.

In order to determine whether the scanner function of the device (the MFP 3) connected to the PC 1 is not available, the following elements are generally utilized:

<dm:required>
<dm:device>scanner</dm:device>
<dm:available>false</dm:available>
</dm:required>.

However, in utilizing the element <dm:required>, the Windows® 7 OS cannot execute the following control.

More specifically, the scanner function of the Windows® 7 OS cannot execute auto toggle control for distinguishing between the USB network connection and the WSD network connection and for executing appropriate control according to each type of connection. Therefore, an appropriate value compliant with each of the interfaces of the PC 1 and the MFP 3 cannot be set in the element <dm:required> as an argument used for launching the TWAIN application 142.

Accordingly, the present exemplary embodiment utilizes the “state where the storage function is available”, which is a function different from and not related to the scanner function. The “state where the storage function is available” is described in the element <dm:required> 846. In other words, by determining the scanner function by identifying the interface between the PC 1 and the device (the MFP 3) by utilizing the “state where the storage function is not available”, the present exemplary embodiment enables appropriate information to be set at the time of launching the TWAIN application 142 as the argument. Thus, the present exemplary embodiment can improve the user operability.

As described above, the condition described in the element <dm:required> 846 corresponds to a case where an image cannot be read via USB connection by using the TWAIN driver. In other words, the condition described in the element <dm:required> 846 corresponds to a case where the PC 1 and the MFP 3 are not mutually connected via the USB interface 14 or the network 4.

In this case, it is useful if the TWAIN application 142 is launched in a state where the TWAIN application 142, at first, displays the scanner selection dialog 625 (FIG. 6D) and the TWAIN driver selected by the user is set in the scanner selection field 621. Accordingly, the present exemplary embodiment sets information for constructing the reading (TWAIN) button 611, which is a trigger for displaying the scanner selection dialog 625 (FIG. 6D).

In an element <dm:execute> TWAINScan.exe “”/devmng </dm:execute> 821, a code “ TWAINScan.exe “ABC Kmmn (TWAIN)” “”/devmng” is set, which describes a function (program) for launching the TWAIN application 142. Accordingly, if the reading (TWAIN) button 611 is pressed by the user, the TWAIN application 142 is launched in the following manner.

More specifically, the TWAIN application 142 is launched in a state where the scanner selection dialog 625 is displayed and the TWAIN driver selected by the user is set in the scanner selection field 621. By executing the above-described processing, the user is enabled to appropriately designate a scanner (driver) desired to be used even when the user has not yet prepared or set the scanner desired to be used. Accordingly, the present exemplary embodiment can achieve a high user operability.

In an element <dm:name xml:lang=“en-US”>Image Scan (TWAIN) </dm:name> 822 included in the element <dm:function> 843, a text string “Image Scan (TWAIN)” is set, which is displayed on the reading (TWAIN) button 611. In an element <dm:required> 847, information describing a condition for displaying the reading (TWAIN) button 611 is set.

An element <dm:device>printer</dm:device> 823 describes that the device connected to the PC 1 includes the printer function. An element <dm:available>true</dm:available> 824 describes that the printer function of the device connected to the PC 1 is currently available. An element <dm:port>WSD</dm:port> 825 describes that the port used for utilizing the printer function of the device is a WSD port. In the present exemplary embodiment, a “WSD port” refers to a port for network connection that utilizes WSD. The element <dm:port>WSD</dm:port> 825 is defined as a function included in the OS as standard.

In determining whether the scanner function of the device (the MFP 3) connected to the PC 1 is available, the element <dm:required> 810 is generally utilized. However, in utilizing the element <dm:required> 810, the Windows® 7 OS cannot execute auto toggle control. More specifically, the Windows® 7 OS, in the scanner function utilizing the TWAIN driver 141, cannot execute auto toggle control by distinguishing between USB connection and WSD connection and by executing appropriate control according to the type of the connection.

Therefore, an appropriate value compliant with each of the interfaces of the PC 1 and the MFP 3 cannot be set in the element <dm:required> 810 as an argument used for launching the TWAIN application 142. Accordingly, the present exemplary embodiment utilizes the “state where the printer function is available” and the name of the port for the printer function, which are functions different from and not related to the scanner function. The “state where the printer function is available” and the name of the port for the printer function are described in the element <dm:required> 847.

In other words, by determining the scanner function by identifying the interface between the PC 1 and the device (the MFP 3) by utilizing the “state where the printer function is available” and the name of the port for the printer function, the present exemplary embodiment enables appropriate information to be set at the time of launching the TWAIN application 142 as the argument. Thus, the present exemplary embodiment can improve the user operability. As described above, the condition described in the element <dm:required> 847 corresponds to a case where an image can be read via WSD network connection by using the TWAIN driver.

An element <dm:execute>TWAINScan.exe “ABC Kmmn (TWAIN) WSD”/devmng</dm:execute> 826, a code “TWAINScan.exe “ABC Kmmn (TWAIN) WSD”/devmng” is set, which describes a function (program) for launching the TWAIN application 142.

Accordingly, if the reading (TWAIN) button 611 is pressed by the user, the TWAIN application 142 is launched in the following manner. More specifically, the TWAIN application 142 is launched in a state where the scanner “ABC Kmmn (TWAIN) WSD”, which corresponds to the WSD network-connected TWAIN driver 141, is set as the default scanner (driver). Accordingly, the present exemplary embodiment can achieve a high user operability.

In the element <dm:function> 844, in an element <dm:name xml:lang=“en-US”>Image Scan (TWAIN) </dm:name> 827 included therein, a text string called “Image Scan (TWAIN)” is set, which is displayed on the reading (TWAIN) button 611. Information describing a condition for displaying the reading (TWAIN) button 611 is set in an element <dm:required> 848.

An element <dm:device>printer</dm:device> 828 describes that the device connected to the PC 1 includes the printer function. An element <dm:available>true</dm:available> 829 describes that the printer function of the device connected to the PC 1 is currently available. In the following description, an attribute “invert=“yes”” means that the logic is reversed.

An element <dm:portinvert=“yes”>LPT</dm:port> 830 describes that the port used for utilizing the printer function of the device is not a local printer (LPT) (parallel) port. An element <dm:portinvert=“yes”>COM</dm:port> 831 describes that the port to be used for utilizing the printer function of the device is not a component object model (COM) (serial) port.

An element <dm:portinvert=“yes”>FILE</dm:port> 832 describes that the port to be used for utilizing the printer function of the device is not a FILE (file export) port.

An element <dm:portinvert=“yes”>IR</dm:port> 833 describes that the port to be used for utilizing the printer function of the device is not an Infrared Data Association (IrDA) (infrared ray) port. An element <dm:portinvert=“yes”>XPS</dm:port> 834 describes that the port to be used for utilizing the printer function of the device is not an eXtended Markup Language (XML) Paper Specification (XPS) (an XPS file export) port.

An element <dm:portinvert=“yes”>BTH</dm:port> 835 describes that the port to be used for utilizing the printer function of the device is not a Bluetooth port. An element <dm:portinvert=“yes”>USB</dm:port> 836 describes that the port to be used for utilizing the printer function of the device is not a USB port. An element <dm:portinvert=“yes”>WSD</dm:port> 837 describes that the port to be used for utilizing the printer function of the device is not a WSD port.

In determining whether the scanner function of the device (the MFP 3) connected to the PC 1 is available, the element <dm:required> 810 is generally utilized. However, in utilizing the element <dm:required> 810, the Windows® 7 OS cannot detect a network connection by an IHV native protocol by using the scanner function that utilizes the TWAIN driver 141.

In the port name of the network by an IHV native protocol for the printer function, a media access control (MAC) address (“ABC_NET_<MAC address>”, for example), which is variable information that is uniquely provided to each device, is included. Accordingly, the port is not included in the OS as standard. Therefore, the port is not defined as a function standard to the OS.

Therefore, it is difficult to distinguish and determine the network port of the IHV native protocol by utilizing the element <dm:port>. As described above, in a state where the network connection by an IHV native protocol is utilized, if the element <dm:required> 810 or the element <dm:required> 847 is utilized, an appropriate value complying with each of the interfaces for the PC 1 and the MFP 3 cannot be set as the argument to be used at the time of launching the TWAIN application 142.

Accordingly, the present exemplary embodiment utilizes the “state where the printer function is available” and the exclusive OR of the name of the port for the printer function, which are functions different from and not related to the scanner function. The “state where the printer function is available” and the logically exclusive name of the port for the printer function are described in the element <dm:required> 848.

In other words, by determining the scanner function by identifying the interface between the PC 1 and the device (the MFP 3) by utilizing the “state where the printer function is available” and the name of the port for the printer function, the present exemplary embodiment enables appropriate information to be set at the time of launching the TWAIN application 142 as the argument. Thus, the present exemplary embodiment can improve the user operability. As described above, the condition described in the element <dm:required> 848 corresponds to a case where an image can be read by using the TWAIN driver via the network connection that uses an IHV native protocol.

A code “TWAINScan.exe “ABC Kmmn (TWAIN) Network”/devmng” is set in an element <dm:execute>TWAINScan.exe “ABC Kmmn (TWAIN) Network”/devmng</dm:execute> 838, which describes a function (program) for launching the TWAIN application 142. Accordingly, if the reading (TWAIN) button 611 is pressed by the user, the TWAIN application 142 is launched in the following manner.

More specifically, the TWAIN application 142 is launched in a state where the scanner “ABC Kmmn (TWAIN) Network”, which corresponds to the TWAIN driver 141 that is connected via the network using an IHV native protocol, is set as the default scanner (driver). Accordingly, the present exemplary embodiment can achieve a high user operability.

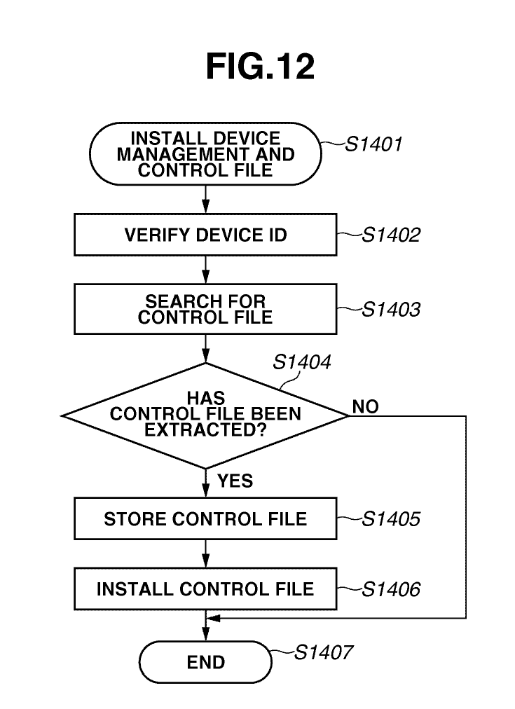

FIG. 10 illustrates an exemplary software configuration of the device management application and the TWAIN application. Referring to FIG. 10, the device management application 80 includes a display unit 901, a device management control unit 902, a link execution unit 903, a device management and control file reading unit 904, and a device management and control file storage unit 905. The device management and control file storage unit 905 stores the device management and control file 800, which is stored in step S1405 (FIG. 12).

The TWAIN application 142 includes a launching source determination unit 906, an application control unit 907, a default device setting unit 908, a reading control unit 909, and a status acquisition unit 910. The reading control unit 909 is a module configured to execute appropriate image processing on the image data read by the MFP 3 and transmitted from the TWAIN driver 141. The display unit 901 is a module configured to monitor the status of the MFP 3 via the TWAIN driver 141 and to acquire a control command that describes the status of the MFP 3.

The device management screen 600 is launched and displayed if the MFP 3 is connected to the PC 1 via the USB interface 14 or the network 4 or if the user selects the device displayed in the folder 500 (FIG. 5A). In the present exemplary embodiment, the case will be primarily described where the MFP 3 is connected to the PC 1 via the USB interface 14 or the network 4 and the device management screen 600 illustrated in FIG. 5B is launched and displayed.

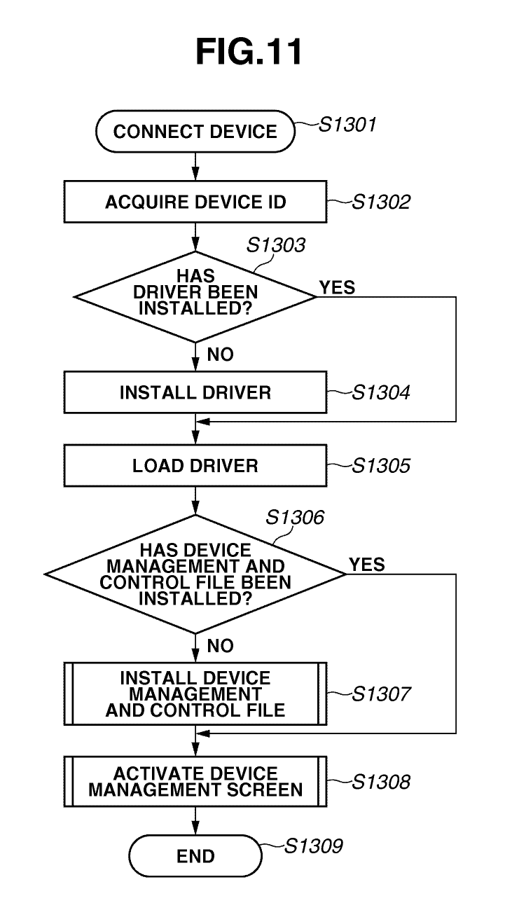

FIG. 11 is a flow chart illustrating an example of processing executed when the device is connected. A program of the processing according to the flow chart of FIG. 11 is loaded and executed by the CPU 204 from the HDD 202 on the RAM 201.

Referring to FIG. 11, in step S1301, the device (the MFP 3) is connected to the PC (the PC 1) via the USB interface 14 or the network 4. In step S1302, the PC 1 acquires an identification (ID) of the connected device. In the present exemplary embodiment, the device ID is described by using a text string, such as “MFG: ABC; MDL: Kmmn; CLS: PRINTER; CMD: K4; DES: ABC Kmmn;”. More specifically, the device ID is a device ID of the printer function of the MFP 3, which the PC 1 can acquire from the MFP 3 via the USB interface 14 or the network 4. The device ID includes the following information:

the manufacturer (MFG:): ABC
the model (MDL:): Kmmn
the class (CLS:): PRINTER
the command (CMD:): K4

(* “K4” is a printer control
Command privately used by
ABC Corporation)

the description (DES:): ABC Kmmn

In step S1303, the device management application 80 determines whether the driver (the printer driver 50, the FAX driver, the WIA driver 703, the WIA driver 704, or the TWAIN driver 141) has been installed on the PC 1. In the following description about the flow chart of FIG. 11, the printer driver 50, the FAX driver, the WIA driver 703, the WIA driver 704, and the TWAIN driver 141 are collectively referred to as a “driver”.

If it is determined that the driver has not been installed on the PC 1 yet (NO in step S1303), then the processing advances to step S1304. In step S1304, the OS installs the driver. In step S1305, the OS loads the driver. If the driver is normally loaded, the device (the MFP 3) is registered in the folder 500 illustrated in FIG. 5A.

In step S1306, the device management application 80 determines whether the device management and control file 800 illustrated in FIGS. 8 and 9 has already been installed on the PC 1. More specifically, in step S1306, the device management application 80 determines whether the already installed device management and control file 800 is compliant with the driver based on the information about the manufacturer (MFG:) and information about the model (MDL:), which is included in the device ID.

If it is determined that the device management and control file 800 has not been installed yet (NO in step S1306), then the processing advances to step S1307. In step S1307, the device management application 80 executes processing for installing the device management and control file 800. The processing for installing the device management and control file 800 will be described in detail below with reference to FIG. 12.

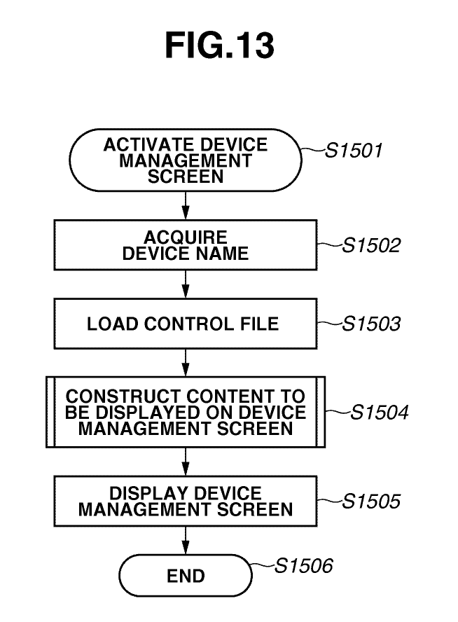

In step S1308, the device management application 80 executes processing for launching a device management screen illustrated in FIG. 13. In step S1309, the device management application 80 ends the processing executed when the device is connected to the PC 1.

On the other hand, if it is determined that the device management and control file 800 has already been installed on the PC 1 (YES in step S1306), then the processing advances to step S1308. On the other hand, if it is determined that the driver has already been installed (YES in step S1303), then the processing advances to step S1305.

FIG. 12 is a flow chart illustrating an example of processing for installing a device management and control file. A program of the processing of the flow chart illustrated in FIG. 12 is loaded and executed by the CPU 204 from the HDD 202 on the RAM 201.

When the processing for installing a device management and control file in step S1307 illustrated in FIG. 11 is executed, the processing in the flow chart of FIG. 12 starts. Referring to FIG. 12, in step S1401, the device management application 80 starts the processing for installing device management and control file.

In step S1402, the device management application 80 confirms the device ID of the device (the MFP 3) connected to the PC 1 via the USB interface 14 or the network 4. In step S1403, the device management application 80 searches for a device management and control file 800 of the device (the MFP 3) connected to the PC 1 based on the manufacturer (MFG:) and the model (MDL:) information included in the device ID.

More specifically, the device management and control file 800 illustrated in FIGS. 8 and 9 includes the manufacturer (MFG:) (“ABC”) and the model (MDL:) (“Kmmn”), which correspond to the device (the MFP 3), in the element <dm:manufacturer> 801 and the element <dm:model> 802.

More specifically, the device management application 80 searches for a device management and control file 800 for the device (the MFP 3) within the file storage portion 11 of the web server 9 or the file storage portion 12 of the CD-ROM 10 inserted in the PC 1.

In step S1404, the device management application 80 determines whether a device management and control file 800 has been extracted from the file storage portion 11 or the file storage portion 12. If it is determined that a device management and control file 800 has been extracted (YES instep S1404), then the processing advances to step S1405. In step S1405, the device management application 80 stores the device management and control file 800 at a predetermined location within the HDD 202 of the PC 1.

In step S1406, the device management application 80 installs the device management and control file 800. After the device management and control file 800 is installed, the processing advances to step S1407. In step S1407, the processing for installing the device management and control file 800 by the device management application 80 ends. In the present exemplary embodiment, it is supposed that the device management and control file 800 compliant with the device (the MFP 3) has been extracted and installed.

If no device management and control file 800 has been extracted (NO in step S1404), then the processing advances to step S1407. In step S1407, the processing for installing the device management and control file 800 by the device management application 80 ends.

FIG. 13 is a flow chart illustrating an example of processing for launching a device management screen. A program of the processing according to the flowchart of FIG. 13 is loaded and executed by the CPU 204 from the HDD 202 on the RAM 201.

When the processing for launching a device management screen in step S1308 illustrated in FIG. 11 is executed, the processing in the flow chart of FIG. 13 starts. Referring to FIG. 13, in step S1501, the device management application 80 starts processing for launching the device management screen. In addition, when the user selects the device 503 within the folder 500, the device management application 80 starts the processing for launching the device management screen.

In step S1502, the device management control unit 902 acquires the device name selected via the folder 500. More specifically, in the present exemplary embodiment, the device management control unit 902 acquires the device name “ABC Kmmn” because the device 503 has been selected.

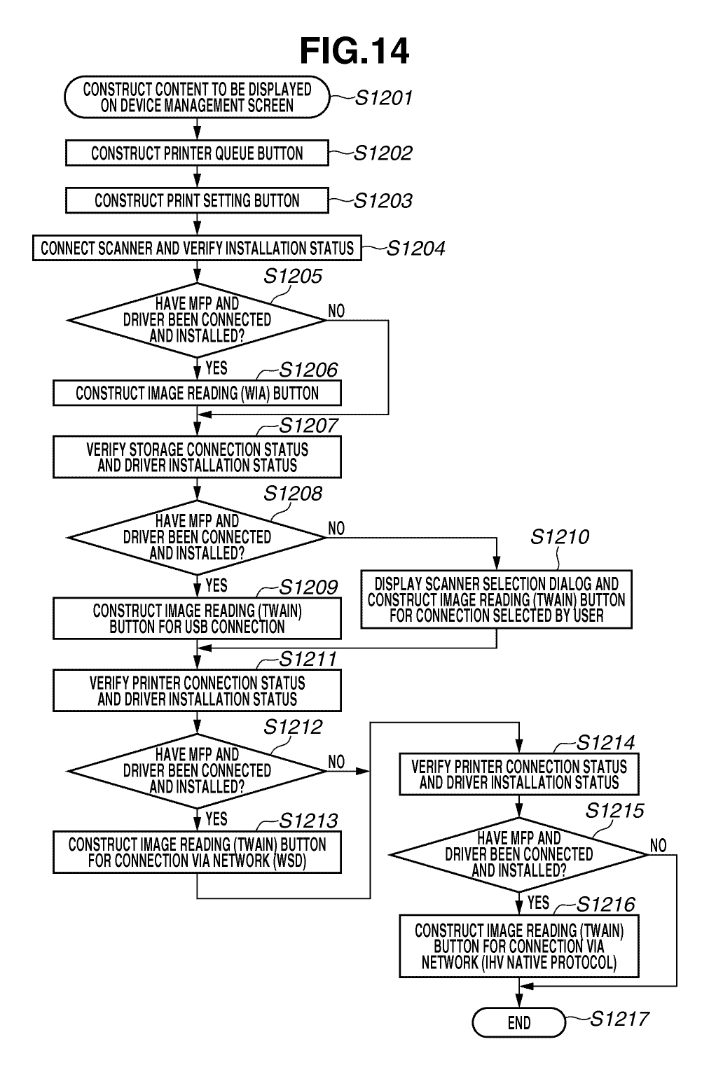

In step S1503, the device management and control file reading unit 904 loads a device management and control file 800 (FIGS. 8 and 9), which has been stored in step S1405 (FIG. 12) based on the acquired device name. In step S1504, the device management control unit 902 executes processing for constructing a content to be displayed on the device management screen based on a device management and control file 800. The processing for constructing a content to be displayed on the device management screen will be described in detail below with reference to FIG. 14.

In step S1505, the device management control unit 902 displays the device management screen 600 via the display unit 901 according to the content to be displayed on the device management screen, which is constructed in step S1504. In step S1506, the processing for launching the device management screen by the device management application 80 ends.

FIG. 14 is a flow chart illustrating an example of processing for constructing a content to be displayed on the device management screen. A program of the processing according to the flow chart of FIG. 14 is loaded and executed by the CPU 204 from the HDD 202 on the RAM 201.

When the processing for constructing a content to be displayed on the device management screen in step S1504 illustrated in FIG. 13 is executed, the processing in the flow chart of FIG. 14 starts. Referring to FIG. 14, in step S1201, the device management control unit 902 starts the processing for constructing a content to be displayed on the device management screen.

In step S1202, the device management control unit 902 constructs a printer queue button 604 according to the content of the element <dm:name> 805 (FIG. 8) and the element <dm:execute> 806 (FIG. 8). Instep S1203, the device management control unit 902 constructs a print setting button 605 according to the content of the element <dm:name> 807 (FIG. 8) and the element <dm:execute> 808 (FIG. 8).

In step S1204, the device management control unit 902 confirms the status of connection of a scanner and the status of installation of the corresponding driver according to the content of the element <dm:device> 811 (FIG. 8) and the element <dm:available> 812 (FIG. 8). In step S1205, the device management control unit 902 determines whether a scanner (the MFP 3) has been connected and the corresponding driver has been installed. If it is determined that the MFP 3 has been connected to the PC 1 via the USB interface 14 and the IHV WIA driver 704 manufactured by ABC Corporation has been installed (YES in step S1205), then the processing advances to step S1206. Furthermore, if it is determined that the MFP 3 has been connected to the PC 1 via the network 4 by using WSD and that the standard WIA driver 703, which is included in the OS as standard, has been installed (YES in step S1205), then the processing advances to step S1206. In none of the above cases (NO in step S1205), then the processing advances to step S1207.

In step S1206, the device management control unit 902 constructs a reading (WIA) button 610 according to the content of the element <dm:name> 809 (FIG. 8) and the element <dm:execute> 813 (FIG. 8). The processing in step S1206 is executed in the case where an image can be read by using the IHV WIA driver 704 or the standard WIA driver 703 via USB connection or via the network that uses WSD.

In step S1207, the device management control unit 902 confirms the status of connection of a storage function and the status of installation of the corresponding driver according to the content of the element <dm:device> 815 (FIG. 8) and the element <dm:available> 816 (FIG. 8). Alternatively, in step S1207, the device management control unit 902 confirms the status of connection of a storage function and the status of installation of the corresponding driver according to the content of the element <dm:device> 819 (FIG. 8) and the element <dm:available> 820 (FIG. 8).

In step S1208, the device management control unit 902 determines whether a storage function has been connected and whether the corresponding driver has been installed. If it is determined that the MFP 3 has been connected to the PC 1 via the USB interface 14 and that a storage class driver, which is included in the OS as standard, has been installed (YES in step S1208), then the processing advances to step S1209. On the other hand, if it is determined that the MFP 3 has been connected to the PC 1 not via the USB interface 14 and that no storage class driver has been installed (NO in step S1208), then the processing advances to step S1210.

In step S1209, the device management control unit 902 constructs a reading (TWAIN) button 611 for USB connection according to the content of the element <dm:name> 814 (FIG. 8) and the element <dm:execute> 817 (FIG. 8). The processing in step S1209 is executed in the case where an image can be read by the TWAIN driver 141 via USB connection.

In step S1210, the device management control unit 902 constructs a reading (TWAIN) button 611 for a connection method selected by the user via the scanner selection dialog 625 (FIG. 6D) according to the content of the element <dm:name> 818 (FIG. 8) and the element <dm:execute> 821 (FIG. 8). The processing in step S1210 is executed in the case where an image cannot be read by the TWAIN driver 141 via USB connection. More specifically, in this case, the connection between the PC 1 and the MFP 3 is implemented not via the USB interface 14 or the network 4.

In this case, it is useful if the TWAIN application 142 is launched in a state where the TWAIN application 142 has at first displayed the scanner selection dialog 625 (FIG. 6D) and where the TWAIN driver selected by the user is set in the scanner selection field 621. Accordingly, the device management control unit 902 constructs a reading (TWAIN) button 611, which is a button for displaying the scanner selection dialog 625 (FIG. 6D).

In step S1211, the device management control unit 902 confirms the status of connection of a printer and the status of installation of the corresponding driver according to the content of the element <dm:device> 823 (FIG. 8), the element <dm:available> 824 (FIG. 8), and the element <dm:port> 825 (FIG. 8). In step S1212, the device management control unit 902 determines whether a printer has been connected and whether the corresponding driver has been installed.

If it is determined that the MFP 3 has been connected to the PC 1 via the network 4 by using WSD and that the printer driver 50 has been installed (YES in step S1212), then the processing advances to step S1213. On the other hand, if it is determined that the MFP 3 has been connected to the PC 1 not via the network 4 by using WSD and that the printer driver 50 has not been installed yet (NO in step S1212), then the processing advances to step S1214.

In step S1213, the device management control unit 902 constructs a reading (TWAIN) button 611 for network connection that uses WSD according to the content of the element <dm:name> 822 (FIG. 8) and the element <dm:execute> 826 (FIG. 8). The processing in step S1213 is executed if an image can be read by the TWAIN driver 141 via the network connection that uses WSD.

In step S1214, the device management control unit 902 confirms the status of connection of a printer and the status of installation of the corresponding driver according to the content of the element <dm:device> 828 (FIG. 9), the element <dm:available> 829 (FIG. 9), and the elements <dm:port> 830 through 837 (FIG. 9). In step S1215, the device management control unit 902 determines whether a printer has been connected and whether the corresponding driver has been installed.

If it is determined that the MFP 3 has been connected to the PC 1 via the network 4 by using the IHV native protocol and that the printer driver 50 has been installed (YES in step S1215), then the processing advances to step S1216. On the other hand, if it is determined that the MFP 3 has been connected to the PC 1 not via the network 4 by using the IHV native protocol and that the printer driver 50 has not been installed yet (NO in step S1215), then the processing advances to step S1217. In step S1217, the processing for constructing the content to be displayed on the device management screen ends.

In step S1216, the device management control unit 902 constructs a reading (TWAIN) button 611 for network connection that uses the IHV native protocol according to the content of the element <dm:name> 827 (FIG. 9) and the element <dm:execute> 838 (FIG. 9). The processing in step S1216 is executed if an image can be read by the TWAIN driver 141 via the network connection that uses the IHV native protocol. Then, the processing advances to step S1217. In step S1217, the processing for constructing the content to be displayed on the device management screen ends.

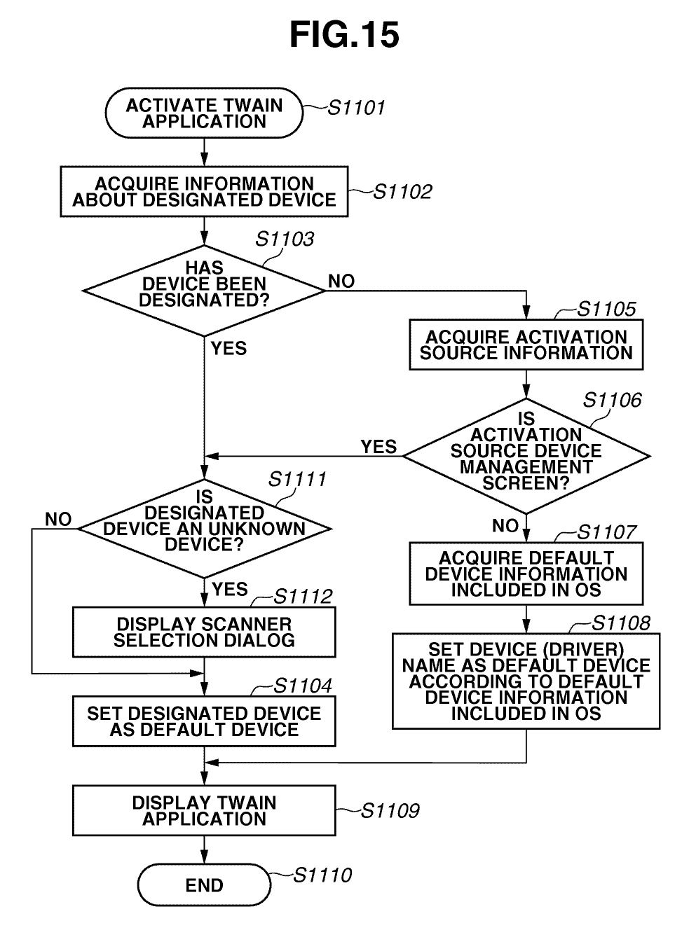

FIG. 15 is a flow chart illustrating an example of processing for launching the TWAIN application. A program of the processing of the flow chart illustrated in FIG. 15 is loaded and executed by the CPU 204 from the HDD 202 on the RAM 201.

When the user presses the reading (TWAIN) button 611 via the device management screen 600 (i.e., when the user gives an instruction for starting image reading processing), the processing according to the flow chart of FIG. 15 starts. Referring to FIG. 15, in step S1101, the processing for launching the TWAIN application 142 starts.

More specifically, in step S1101, the device management control unit 902, which is included in the device management application 80 illustrated in FIG. 10, transmits the information described in the element <dm:execute> 817, 821, 826, or 838 (FIGS. 8 and 9) to the application control unit 907 via the link execution unit 903. In step S1102, the application control unit 907 acquires device designation information, which is described by using the name of the TWAIN driver that is a first argument. In step S1103, to confirm the name of the TWAIN driver that is the first argument, the application control unit 907 determines whether device designation information exists (i.e., whether a device has been designated). If it is determined that a device has been designated (i.e., that device designation information exists) (YES in step S1103), then the processing advances to step S1111. On the other hand, if it is determined that no device has been designated (i.e., that no device designation information exists) (NO in step S1103), then the processing advances to step S1105.

In the present exemplary embodiment, the device is designated by using the name of the TWAIN driver that is the first argument, which is described in the element <dm:execute> 817, 821, 826, or 838 (FIGS. 8 and 9). Accordingly, in this case, the processing advances from step S1103 to step S1111. If the TWAIN application 142 has been launched without setting a first argument, then the processing advances from step S1103 to step S1105.

In step S1111, the application control unit 907 determines whether the TWAIN driver name, which is the first argument, has a value “” (“null”) (i.e., whether the device is an unknown device). If it is determined that the TWAIN driver name, which is the first argument, has a value “” (“null”) (i.e., that the device is an unknown device) (YES in step S1111), then the processing advances to step S1112. On the other hand, if it is determined that the TWAIN driver name does not have a value “” (“null”) (i.e., that the device is not an unknown device) (NO in step S1111), then the processing advances to step S1104. In step S1112, the application control unit 907 displays the scanner selection dialog 625 (FIG. 6D). When the user selects a TWAIN driver via the scanner selection field 626 and presses the OK button 627, the application control unit 907 sets the scanner designated with the name of the selected TWAIN driver as the first argument. Then, the processing advances to step S1104.

In step S1104, the default device setting unit 908 sets the designated device (i.e., the scanner designated by using the TWAIN driver name) as the default device for the TWAIN application 142. Then, the processing advances to step S1109. In step S1105, the application control unit 907 transmits the information received from the device management control unit 902 via the link execution unit 903 in step S1101 to the launching source determination unit 906. The information transmitted from the application control unit 907 to the launching source determination unit 906 in step S1105 is the information described in the element <dm:execute> 817, 821, 826, or 838 illustrated in FIGS. 8 and 9. More specifically, in step S1105, the launching source determination unit 906 acquires information about the launching source, which is a second argument.

In step S1106, the launching source determination unit 906 determines whether the launching source is the device management screen. If it is determined that the launching source is the device management screen (the device management screen 600 in the present exemplary embodiment) (YES in step S1106), then the processing advances to step S1104. On the other hand, if it is determined that the launching source is a portion other than the device management screen (NO in step S1106), then the processing advances to step S1107.

In the present exemplary embodiment, the device management screen 600 is designated as the launching source according to the second argument (“/devmnb”), which is described in the element <dm:execute> 817, 821, 826, or 838 illustrated in FIGS. 8 and 9. Accordingly, in this case, the processing advances from step S1106 to step S1104. On the other hand, if it is determined that the TWAIN application 142 has been launched from a portion other than the device management screen (NO in step S1106), the processing advances from step S1106 to step S1104 because “/other” has been designated as the second argument, which corresponds to the launching source.

In step S1107, the default device setting unit 908 acquires information about a default device of the OS via the application/DDI interface 84. In the present exemplary embodiment, the “default device” refers to a device to which the default mark 502 has been set in the folder 500 illustrated in FIG. 5A. More specifically, in the present exemplary embodiment, because the device 501 (“XYZ Defg”) has been set as the default device, the default device setting unit 908 acquires the device name “XYZ Defg” in step S1107.

In step S1108, the default device setting unit 908 sets the device (driver) name as the default device of the TWAIN application 142 according to the default device of the OS acquired in step S1107. Then the processing advances to step S1109. In step S1108, if the default device setting unit 908 cannot extract an appropriate device (driver) name from the default device of the OS acquired in step S1107, then the default device setting unit 908 sets the device (driver) name set in a previous launch of the TWAIN application 142 as the default device.

In step S1109, the application control unit 907 displays the TWAIN application 142. In step S1110, the processing for launching the TWAIN application ends. In this case, the TWAIN application 142 has been launched and displayed in the state in which the default device set in step S1108 is selected. The information about the default device for the TWAIN application 142 is stored on a memory of the RAM 201, which is managed by the TWAIN application 30.

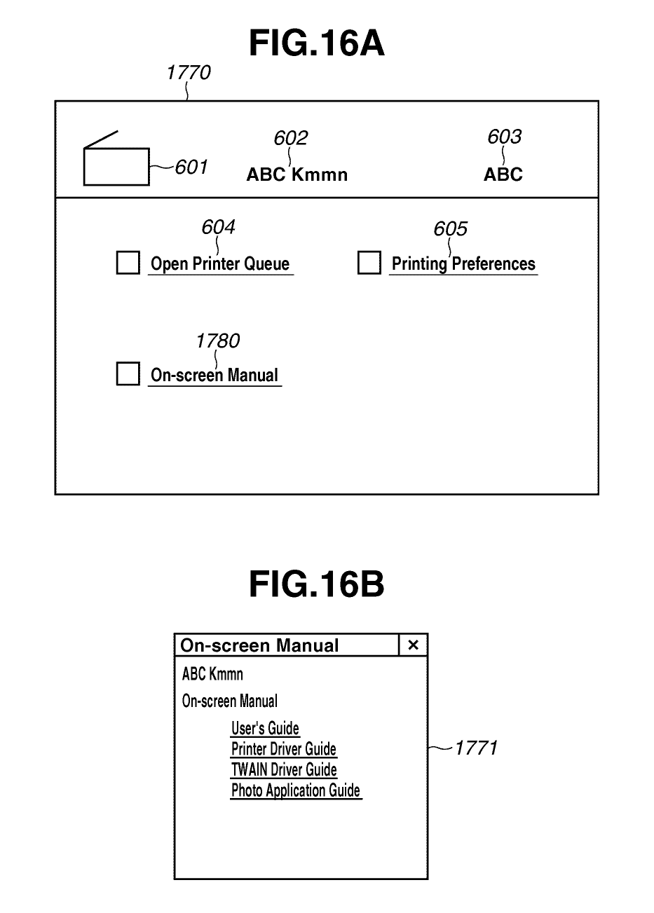

Now, a second exemplary embodiment of the present invention will be described in detail below. FIGS. 16A and 16B illustrate an example of a device management screen and a manual therefor. In the example illustrated in FIG. 16A, components similar to those of the first exemplary embodiment described above with reference to FIG. 5B are provided with the same reference numerals. Accordingly, the description thereof will not be repeated here.

Referring to FIG. 16A, a device management screen 1770 is launched and displayed when the user selects the device 503 via the Devices and Printers folder 500. The user can manage the MFP 3 via the device management screen 1770.

In the lower portion of the device management screen 1770, a link to the function associated with the device 503 is displayed. More specifically, a printer queue button 604, a print setting button 605, and a manual display button 1780 are displayed.

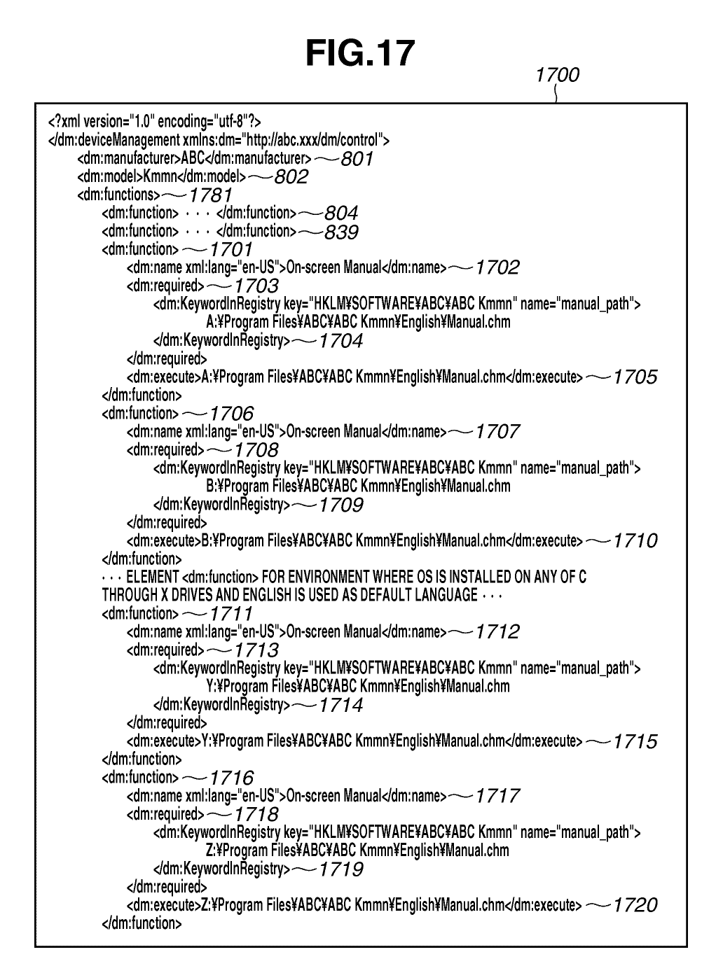

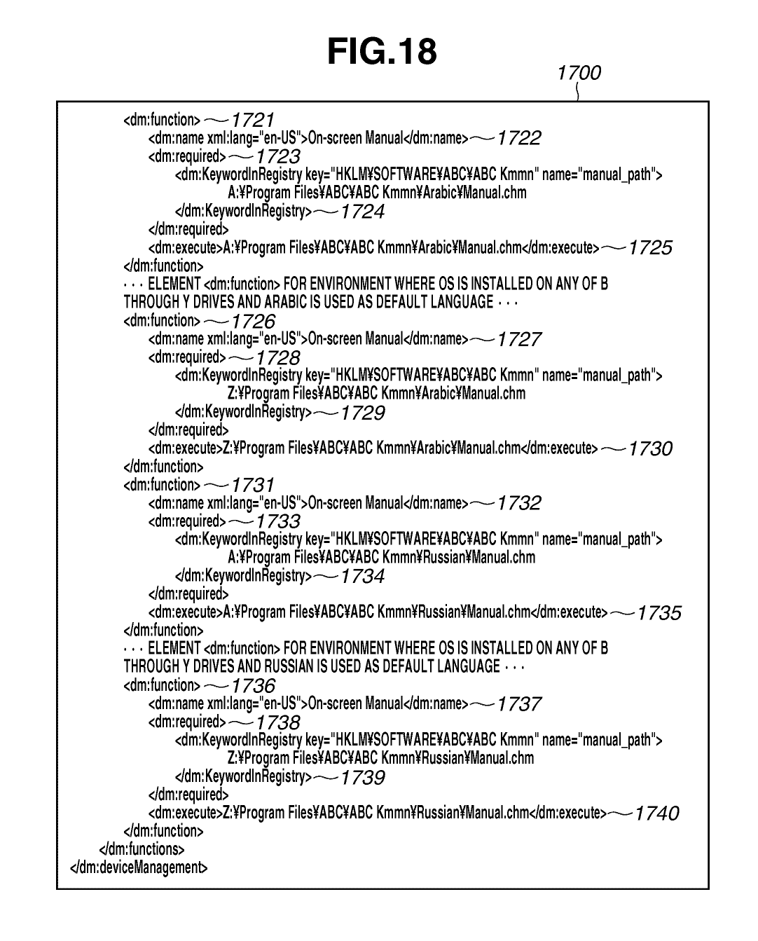

In an element <dm:functions> 1781 (FIGS. 17 and 18), elements <dm:function> 804, 839, 1701, 1706, 1711, 1716, 1721, 1726, 1731, and 1736, each of which describing each corresponding button and function, are described. The manual display button 1780 is a button for displaying a manual 1771 (FIG. 16B), which describes how to operate the MFP 3. When the user presses the manual display button 1780, the manual 1771, which has been previously installed at a predetermined location within the PC 1, is launched and displayed.

Referring to FIG. 16B, the manual 1771 is a manual describing how to operate the MFP 3. The manual 1771 includes a Compiled Help Module (CHM) file (Manual.chm). More specifically, the manual 1771, which depends on the model of the MFP 3 and the language used thereon, is installed by a dedicated setup application at the following predetermined location. In addition, the setup application describes a file path to the installation location of the manual 1771 as the following registry information (text string (Type: REG_SZ)).

[Case Where the OS is installed on C Drive And English is Used
as the Language of the OS]

Installation location:

C:¥Program Files¥ABC¥ABC Kmmn¥English¥Manual.chm

Registry information:

HKEY_LOCAL_MACHINE¥SOFTWARE¥ABC¥ABC
Kmmn¥

Name Data
manual_path:

C:¥Program Files¥ABC¥ABC Kmmn¥English¥Manual.chm

[Case Where the OS is installed on E Drive And Japanese is Used
as the Language of the OS]

Installation location:

E:¥Program Files¥ABC¥ABC Kmmn¥Japanese¥Manual.chm

Registry information:

HKEY_LOCAL_MACHINE¥SOFTWARE¥ABC¥ABC
Kmmn¥

Name Data
manual_path:

E:¥Program Files¥ABC¥ABC Kmmn¥Japanese¥Manual.chm

[Case Where the OS is installed on H Drive And Arabic is Used
as the Language of the OS]

Installation location:

H:¥Program Files¥ABC¥ABC Kmmn¥Arabic¥Manual.chm

Registry information:

HKEY_LOCAL_MACHINE¥SOFTWARE¥ABC¥ABC
Kmmn¥

Name Data
manual_path:

H:¥Program Files¥ABC¥ABC Kmmn¥Arabic¥Manual.chm

[Case Where the OS is installed on K Drive And Russian is Used
as the Language of the OS]

Installation location:

K:¥Program Files¥ABC¥ABC Kmmn¥Russian¥Manual.chm

Registry information:

HKEY_LOCAL_MACHINE¥SOFTWARE¥ABC¥ABC
KmmnY

Name Data
manual_path:

K:¥Program Files¥ABC¥ABC Kmmn¥Russian¥Manual.chm

In launching the manual 1771 from another application, the user generally acquires a full path to the manual 1771 based on the registry information and launches the manual 1771 by using the full path. In the present exemplary embodiment, manuals of four language versions, i.e., English, Japanese, Arabic, and Russian versions, are provided as the manual for the MFP 3.

FIGS. 17 and 18 illustrate an example of a content of the device management and control file. Referring to FIG. 17, a device management and control file 1700 is a file for the OS whose language is English. Information illustrated in FIGS. 17 and 18 is stored on the file storage portion 11 or the file storage portion 12. The content of the examples illustrated in Fig. FIGS. 17 and 18 that is similar to that described above in the first exemplary embodiment with reference to FIGS. 8 and 9 will not be repeatedly described in detail.

Referring to FIG. 17, information used for constructing the device management screen 1770 is described in the device management and control file 1700. On the device management screen 1770, which is launched and displayed when the MFP 3 is connected to the PC 1, in order to display the buttons illustrated in FIGS. 16A and 16B (i.e., the printer queue button 604, the print setting button 605, and the manual display button 1780), elements <dm:function> 804, 839, 1701, 1706, 1711, 1716, 1721, 1726, 1731, and 1736, each of which describing each corresponding button and function, are described in the element <dm:functions> 1781.

In an element <dm:name xml:lang=“en-US”>On-screen Manual</dm:name> 1702 included in the element <dm:function> 1701, a text string “On-screen Manual”, which is displayed on the manual display button 1780, is set. In an element <dm:required> 1703, information about a condition for displaying the manual display button 1780 is set.

The element <dm:keyword In Registry> 1704 describes that the following information has been set as the registry information:

Registry information:

HKEY_LOCAL_MACHINE¥SOFTWARE¥ABC¥ABC Kmmn¥

Name Data
manual_path:

A:¥Program Files¥ABC¥ABC Kmmn¥English¥Manual.chm

In the above-described case, the OS is installed on the A drive and English has been set as the default language of the OS.

In the examples illustrated in FIGS. 17 and 18, “HKLM” is abbreviation for “HKEY_LOCAL_MACHINE”. The text string “HKLM” is converted into “HKEY_LOCAL_MACHINE” within the OS to be processed.

If the OS has been installed on the A drive and English is used as the default language of the OS and if an English version of the manual 1771 has been installed, then a full path to the manual 1771 is set in an element <dm:execute> 1705. In an element <dm:name xml:lang=“en-US”>On-screen Manual</dm:name> 1707 included in the element <dm:function> 1706, a text string “On-screen Manual” is set, which is displayed on the manual display button 1780.

Information about a condition for displaying the manual display button 1780 is set in an element <dm:required> 1708. An element <dm:keyword In Registry> 1709 describes that the following information has been set as the registry information:

Registry information:

HKEY_LOCAL_MACHINE¥SOFTWARE¥ABC¥ABC Kmmn¥

Name Data
manual_path:

B:¥Program Files¥ABC¥ABC Kmmn¥English¥Manual.chm

In the above-described case, the OS is installed on the B drive and English has been set as the default language of the OS.

If the OS has been installed on the B drive and English is used as the default language of the OS and if an English version of the manual 1771 has been installed, then a full path to the manual 1771 is set in an element <dm:execute> 1710. For an element <dm:function> in the case where the OS has been installed on any of C through X drives and English is set as the default language of the OS, the information about the OS installation destination drive only is different from that in the case of the element <dm:function> 1701 and the element <dm:function> 1706. Accordingly, the cases will not be illustrated in the drawing.

In an element <dm:name xml:lang=“en-US”>On-screen Manual</dm:name> 1712 included in the element <dm:function> 1711, a text string “On-screen Manual” is set, which is displayed on to the manual display button 1780. Information about a condition for displaying the manual display button 1780 is set in an element <dm:required> 1713.

An element <dm:keyword In Registry> 1714 corresponds to the case where the following information has been set as the registry information:

Registry information:

HKEY_LOCAL_MACHINE¥SOFTWARE¥ABC¥ABC Kmmn¥

Name Data
manual_path:

Y:¥Program Files¥ABC¥ABC Kmmn¥English¥Manual.chm

In the above-described case, the OS is installed on the Y drive and English has been set as the default language of the OS.

If the OS has been installed on the B drive and English is used as the default language of the OS and if an English version of the manual 1771 has been installed, then a full path to the manual 1771 is set in an element <dm:execute> 1715. In an element <dm:name xml:lang=“en-US”>On-screen Manual</dm:name> 1717 included in the element <dm:function> 1716, a text string “On-screen Manual” is set, which is displayed on the manual display button 1780.

Information about a condition for displaying the manual display button 1780 is set in an element <dm:required> 1718. The element <dm:keyword In Registry> 1719 describes that the following information has been set as the registry information:

Registry information:

HKEY_LOCAL_MACHINE¥SOFTWARE¥ABC¥ABC Kmmn¥

Name Data
manual_path:

Z:¥Program Files¥ABC¥ABC Kmmn¥English¥Manual.chm

In the above-described case, the OS is installed on the Z drive and English has been set as the default language of the OS.

If the OS has been installed on the Z drive and English is used as the default language of the OS and if an English version of the manual 1771 has been installed, then a full path to the manual 1771 is set in an element <dm:execute> 1720.

The OS can be logically installed on any of A through Z drives. In the present exemplary embodiment, the elements <dm:function> 1701 through 1716 described above are provided. Accordingly, if the OS has been installed on an arbitrary drive among the A through Z drives, the manual display button 1780 can be normally displayed. In addition, when the user presses the manual display button 1780, the present exemplary embodiment can normally display the English manual 1771. Accordingly, the present exemplary embodiment can achieve a high user operability.

In the present exemplary embodiment, it is supposed that English and Japanese versions are provided for the device management and control file 1700. In the Japanese version of the device management and control file 1700, the text string “English” is substituted with another text string “Japanese”. More specifically, focusing on the element <dm:function> 1701, the device management and control file 1700 includes the following content:

<dm:function>
<dm:name xml:lang=“en-US”>On-screen Manual</dm:name>
<dm:required>
<dm:keyword In Registry key=“HKLM¥SOFTWARE¥ABC¥ABC
Kmmn”
name=“manual_path”>
A:¥Program Files¥ABC¥ABC Kmmn¥Japanese¥Manual.chm
</dm:keyword In Registry>
</dm:required>
<dm:execute>
A:¥Program Files¥ABC¥ABC Kmmn¥Japanese¥Manual.chm
</dm:execute>
</dm:function>

Accordingly, if the default language of the OS is Japanese and if the OS has been installed on any arbitrary driver among the A through Z drives, the present exemplary embodiment can normally display the manual display button 1780. Therefore, when the user presses the manual display button 1780, the present exemplary embodiment can normally display the Japanese version of the manual 1771. Accordingly, the present exemplary embodiment can achieve a high user operability.

If any language other than English and Japanese is used as the default language of the OS, the device management and control file 1700 for the other language is not provided. Accordingly, the English version of the device management and control file 1700 is installed and referred to by the user as the device management and control file for the default language.

Therefore, if the default language of the OS is Arabic, whose manual 1771 is available, the manual display button 1780 for displaying the manual 1771 for Arabic or any languages other than English and Japanese cannot be displayed according to the elements <dm:function> 1701 through 1716. In other words, elements <dm:function> 1721 through 1736 (FIG. 18) are to be provided, which are elements dedicated for languages whose manual 1771 has been provided but whose device management and control file 1700 has not been provided.

In an element <dm:name xml:lang=“en-US”>On-screen Manual</dm:name> 1722 included in the element <dm:function> 1721, a text string “On-screen Manual” is set, which is displayed on the manual display button 1780. Information about a condition for displaying the manual display button 1780 is set in the element <dm:required> 1723.

The element <dm:keyword In Registry> 1724 describes that the following information has been set as the registry information:

Registry information:

HKEY_LOCAL_MACHINE¥SOFTWARE¥ABC¥ABC Kmmn¥

Name Data
manual_path:

A:¥Program Files¥ABC¥ABC Kmmn¥Arabic¥Manual.chm

In the above-described case, the OS is installed on the A drive and Arabic has been set as the default language of the OS.

If the OS has been installed on the A drive and Arabic is used as the default language of the OS and if an Arabic version of the manual 1771 has been installed, then a full path to the manual 1771 is set in the element <dm:execute> 1725. For an element <dm:function> in the case where the OS has been installed on any of B through Y drives and Arabic is set as the default language of the OS, the information about the OS installation destination drive only is different from that in the case of the element <dm:function> 1721. Accordingly, the cases will not be illustrated in the drawing.

In an element <dm:name xml:lang=“en-US”>On-screen Manual</dm:name> 1727 included in the element <dm:function> 1726, a text string “On-screen Manual” is set, which is displayed on the manual display button 1780. Information about a condition for displaying the manual display button 1780 is set in the element <dm:required> 1728.

The element <dm:keyword In Registry> 1729 describes that the following information has been set as the registry information:

Registry information:

HKEY_LOCAL_MACHINE¥SOFTWARE¥ABC¥ABC Kmmn¥

Name Data
manual_path:

Z:¥Program Files¥ABC¥ABC Kmmn¥Arabic¥Manual.chm

In the above-described case, the OS is installed on the Z drive and Arabic has been set as the default language of the OS.

If the OS has been installed on the Z drive and Arabic is used as the default language of the OS and if an Arabic version of the manual 1771 has been installed, then a full path to the manual 1771 is set in an element <dm:execute> 1730.

In an element <dm:name xml:lang=“en-US”>On-screen Manual</dm:name> 1732 included in the element <dm:function> 1731, a text string “On-screen Manual” is set, which is displayed on the manual display button 1780. Information about a condition for displaying the manual display button 1780 is set in the element <dm:required> 1733.

The element <dm:keyword In Registry> 1734 describes that the following information has been set as the registry information:

Registry information:

HKEY_LOCAL_MACHINE¥SOFTWARE¥ABC¥ABC Kmmn¥

Name Data
manual_path:

A:¥Program Files¥ABC¥ABC Kmmn¥Russian¥Manual.chm

In the above-described case, the OS is installed on the A drive and Russian has been set as the default language of the OS.

If the OS has been installed on the A drive and Russian is used as the default language of the OS and if a Russian version of the manual 1771 has been installed, then a full path to the manual 1771 is set in the element <dm:execute> 1735. For an element <dm:function> in the case where the OS has been installed on any of B through Y drives and Russian is set as the default language of the OS, the information about the OS installation destination drive only is different from that in the case of the element <dm:function> 1731. Accordingly, the cases will not be illustrated in the drawing.

In an element <dm:name xml:lang=“en-US”>On-screen Manual</dm:name> 1737 included in the element <dm:function> 1736, a text string “On-screen Manual” is set, which is displayed on the manual display button 1780. Information about a condition for displaying the manual display button 1780 is set in an element <dm:required> 1738.

The element <dm:keyword In Registry> 1739 describes that the following information has been set as the registry information:

Registry information:

HKEY_LOCAL_MACHINE¥SOFTWARE¥ABC¥ABC Kmmn¥

Name Data
manual_path:

Z:¥Program Files¥ABC¥ABC Kmmn¥Russian¥Manual.chm

In the above-described case, the OS is installed on the Z drive and Russian has been set as the default language of the OS.

If the OS has been installed on the Z drive and Russian is used as the default language of the OS and if a Russian version of the manual 1771 has been installed, then a full path to the manual 1771 is set in an element <dm:execute> 1740.

As in the case where Arabic or Russian has been set as the default language in the present exemplary embodiment, the present exemplary embodiment having the above-described configuration particularly provides the elements <dm:function> 1721 through 1736 (FIG. 18), which are elements dedicated for languages whose manual 1771 has been provided but whose device management and control file 1700 has not been provided.

Accordingly, if any arbitrarily selected language other than English and Japanese has been set as the default language of the OS, the present exemplary embodiment can normally display the manual display button 1780. Therefore, when the user presses the manual display button 1780, the present exemplary embodiment can normally display the appropriate version of the manual 1771 corresponding to the language other than English and Japanese. Accordingly, the present exemplary embodiment can achieve a high user operability.

For the languages other than English and Japanese, the OS can be logically installed on any of A through Z drives. In the present exemplary embodiment, the elements <dm:function> 1721 through 1726 and 1731 through 1736 described above are provided. Accordingly, if the OS has been installed on an arbitrary drive among the A through Z drives, the manual display button 1780 can be normally displayed. In addition, when the user presses the manual display button 1780, the present exemplary embodiment can normally display the appropriate version of the manual 1771 corresponding to the default language of the OS. Accordingly, the present exemplary embodiment can achieve a high user operability.

FIG. 19 is a flow chart illustrating an example of processing for constructing a content to be displayed on the device management screen. A program of the processing according to the flow chart of FIG. 19 is loaded and executed by the CPU 204 from the HDD 202 on the RAM 201.

When the processing for constructing a content to be displayed on the device management screen in step S1504 illustrated in FIG. 13 is executed, the processing in the flow chart of FIG. 19 starts. Referring to FIG. 19, in step S1901, the device management control unit 902 starts the processing for constructing a content to be displayed on the device management screen.

In step S1902, the device management control unit 902 constructs a printer queue button 604. In step S1903, the device management control unit 902 constructs a print setting button 605. In step S1904, the device management control unit 902 confirms the status of installation of a manual 1771 for a language that is the same as the default language set for the OS. In step S1905, the device management control unit 902 determines whether a manual 1771 for a language that is the same as the default language set for the OS has been installed. In the example illustrated in FIG. 17, the element <dm:keyword In Registry> 1704 describes that the OS has been installed on the A drive.

If it is determined that a manual 1771 for a language that is the same as the default language set for the OS has been installed (YES in step S1905), then the processing advances to step S1906. On the other hand, if it is determined that a manual 1771 for a language that is the same as the default language set for the OS has not been installed yet (NO in step S1905), then the processing advances to step S1907.

In step S1906, the device management control unit 902 constructs a manual display button 1780 for displaying the manual 1771 for the language that is the same as the default language of the OS according to the content of the element <dm:name> 1702 (FIG. 17) and the element <dm:execute> 1705 (FIG. 17). The element <dm:name> 1702 and the element <dm:execute> 1705 illustrated in FIG. 17 correspond to the case where the OS has been installed on the A drive.

In step S1907, the device management control unit 902 confirms the installation status of the Arabic version of the manual 1771 according to the content of the element <dm:keyword In Registry> 1724 (FIG. 18). The content of the element <dm:keyword In Registry> 1724 (FIG. 18) corresponds to the case where the OS has been installed on the A drive. In step S1908, the device management control unit 902 determines whether the Arabic version of the manual 1771 has been installed. If it is determined that the Arabic version of the manual 1771 has been installed (YES in step S1908), then the processing advances to step S1909. On the other hand, if it is determined that the Arabic version of the manual 1771 has not been installed (NO in step S1908), then the processing advances to step S1910.

In step S1909, the device management control unit 902 constructs a manual display button 1780 for displaying the Arabic version of the manual 1771 according to the content of the element <dm:name> 1722 (FIG. 18) and the element <dm:execute> 1725 (FIG. 18). The element <dm:name> 1722 and the element <dm:execute> 1725 illustrated in FIG. 18 correspond to the case where the OS has been installed on the A drive.

In step S1910, the device management control unit 902 confirms the installation status of the Russian version of the manual 1771 according to the content of the element <dm:keyword In Registry> 1734 (FIG. 18). The element <dm:keyword In Registry> 1734 illustrated in FIG. 18 corresponds to the case where the OS has been installed on the A drive. In step S1911, the device management control unit 902 determines whether the Russian version of the manual 1771 has been installed.

If it is determined that the Russian version of the manual 1771 has been installed (YES in step S1911), then the processing advances to step S1912. On the other hand, if it is determined that the Russian version of the manual 1771 has not been installed (NO in step S1911), then the processing advances to step S1913. In step S1913, the processing for constructing the content to be displayed on the device management screen ends.

In step S1912, the device management control unit 902 constructs a manual display button 1780 for displaying the Russian version of the manual 1771 according to the content of the element <dm:name> 1732 (FIG. 18) and the element <dm:execute> 1735 (FIG. 18). Then, the processing advances to step S1913. In step S1913, the processing for constructing the content to be displayed on the device management screen ends. The element <dm:name> 1732 and the element <dm:execute> 1735 illustrated in FIG. 18 correspond to the case where the OS has been installed on the A drive.

In the above-described first exemplary embodiment, the MFP 3, which includes the functions of a color inkjet printer, a color facsimile apparatus, and a color scanner, and an external storage device for a flash memory is used as an example of a peripheral apparatus. In addition, the above-described first exemplary embodiment provides a function of an appropriate device according to the environment of use by the user by utilizing statuses and port names described in the following items (1) through (4):

(1) A state in which the storage function, which is different from and not related to the scanner function, is available

(2) A state in which the storage function, which is different from and not related to the scanner function, is not available

(3) A state in which the storage function, which is different from and not related to the scanner function, is available and the port name of the port used for the printer function

(4) A state in which the storage function, which is different from and not related to the scanner function, is available and exclusive OR for the port name of the port used for the printer function

However, if an MFP that does not include an external storage device but includes a printer and a scanner only, an MFP that does not include a printer but includes a scanner, a facsimile apparatus, and an external storage device only, or a single-function color scanner which does not include functions of a printer and an external storage device, is used as an example of the peripheral apparatus, then the purpose of the present invention cannot be achieved by the above-described first exemplary embodiment.

In a third exemplary embodiment of the present invention, a peripheral apparatus control system including an arbitrary peripheral apparatus, such as the above-described MFP or a single-function scanner that can implement the present invention will be described. In the third exemplary embodiment described below, it is supposed that the MFP 3 is a single-function scanner that does not include a printer function or an external storage device.

FIG. 20 illustrates an example of a device management and control file. Referring to FIG. 20, a device management and control file 950 is a file for an English OS. Information illustrated in FIG. 20 is stored in the file storage portions 11 and 12. The content of the information illustrated in FIG. 20 that is the same as that of the information illustrated in FIG. 8 will not be described in detail here again.

In an element <dm:name xml:lang=“en-US”>Image Scan (TWAIN) </dm:name> 952 included IN an element <dm:function> 951, a text string “Image Scan (TWAIN)” to be displayed on the reading (TWAIN) button 611 is set. In an element <dm:required> 953, information describing a condition for displaying the reading (TWAIN) button 611 is set. In an element <dm:keywordInRegistry key=“HKCU¥Software¥ABC¥Network Utility¥Kmmn” name=“active” option=“notEqual”></dm:keywordInRegistry> 954, registry information is set as the above-described condition. More specifically, a code “notEqual”, which is designated as an “option” attribute, means “not matching”. Accordingly, if the registry information included in the element <dm:keywordInRegistry key=“HKCU¥Software¥ABC¥Network Utility¥Kmmn” name=“active” option=“notEqual”></dm:keywordInRegistry> 954 does not match the following registry information, then the reading (TWAIN) button 611 is displayed:

HKEY_CURRENT_USER_MACHINE¥Software¥ABC¥Network

Utility¥Kmmn¥

Name: active
Type: REG_SZ
Data: none

More specifically, if an arbitrary value, such as “0”, “1”, or “2” is set to the apparatus “active”, then the reading (TWAIN) button 611 is displayed.

In an element<dm:execute>TWAINScan.exe “ABC Kmmn (TWAIN)”/devmng</dm:execute> 955, a code “TWAINScan.exe“ABCKmmn(TWAIN)”/devmng”, which describes the function (program) for launching the TWAIN application 142 is set. Accordingly, if the reading (TWAIN) button 611 is pressed by the user, the TWAIN application 142 is launched in a state where the code “ABC Kmmn (TWAIN)”, which denotes the TWAIN driver 141 used via USB connection has been set as the default scanner (driver). Accordingly, the present exemplary embodiment can improve the user operability.

In an element <dm:name xml:lang=“en-US”>Image Scan (TWAIN)—Select Device</dm:name> 957 included in an element <dm:function> 956, a text string “Image Scan (TWAIN)—Select Device” to be displayed on the reading (TWAIN) button 611 is set. Because the text string set to the element <dm:name> is used as the text string displayed on the reading (TWAIN) button 611, the text string displayed on the reading (TWAIN) button 611 may be different from the text string illustrated in FIG. 5B.

Information describing a condition for displaying the reading (TWAIN) button 611 is set in an element <dm:required> 958. In an element <dm:keywordInRegistry key=“HKCU¥Software¥ABC¥Network Utility¥Kmmn” name=“active” option=“equal”>0 </dm:keywordInRegistry> 959, registry information is set as the above-described condition. More specifically, a code “equal”, which is designated as an “option” attribute, means “matching”. Accordingly, if the registry information included in the element <dm:keywordInRegistry key=“HKCU¥Software¥ABC¥Network Utility¥Kmmn” name=“active” option=“equal”>0 </dm:keywordInRegistry> 959 matches the following registry information, then the reading (TWAIN) button 611 is displayed:

HKEY_CURRENT_USER_MACHINE¥Software¥ABC¥Network

Utility¥Kmmn¥

Name: active
Type: REG_SZ
Data: 0

More specifically, if the value “0” is set to the apparatus “active”, the reading (TWAIN) button 611 is displayed.

In an element <dm:execute>TWAINScan.exe “”/devmng</dm:execute> 960, the code “TWAINScan.exe “”/devmng”, which denotes the function (program) for launching the TWAIN application 142 is set. Accordingly, if the reading (TWAIN) button 611 is pressed by the user, the TWAIN application 142 is launched in the following manner.

More specifically, at first, in a state where the scanner selection dialog 625 (FIG. 6D) is displayed and the TWAIN driver selected by the user is set in the scanner selection field 621, the TWAIN application 142 is launched. By executing the above-described processing, the user is enabled to appropriately designate a scanner (driver) desired to be used even when the user has not yet prepared or set the scanner desired to be used. Accordingly, the present exemplary embodiment can achieve a high user operability.

In an element <dm:name xml:lang=“en-US”>Image Scan (TWAIN) </dm:name> 962 included in an element <dm:function> 961, a text string “Image Scan (TWAIN)” is set to the reading (TWAIN) button 611. In an element <dm:required> 963, information describing a condition for displaying the reading (TWAIN) button 611 is set.

In an element <dm:keywordInRegistry key=“HKCU¥Software¥ABC¥Network Utility¥Kmmn” name=“active” option=“greater”>0</dm:keywordInRegistry> 964, registry information is set as the above-described condition. In addition, a code “greater”, which is designated as the “option” attribute, means “greater than . . . ”. Accordingly, if a value greater than the value of the following registry information is set, the reading (TWAIN) button 611 is displayed:

HKEY_CURRENT_USER_MACHINE¥Software¥ABC¥Network

Utility¥Kmmn¥

Name: active
Type: REG_SZ
Data: 0

More specifically, if a value greater than “0” is set to the apparatus “active”, then the reading (TWAIN) button 611 is displayed.

In an element <dm:execute>TWAINScan.exe “ABC Kmmn (TWAIN) Network”/devmng</dm:execute> 965, a code “TWAINScan.exe” ABC Kmmn (TWAIN) Network”/devmng”, which describes the function (program) for launching the TWAIN application 142, is set. Accordingly, if the reading (TWAIN) button 611 is pressed by the user, the TWAIN application 142 is launched in the following manner.

More specifically, the TWAIN application 142 is launched in a state where a code “ABCKmmn (TWAIN) Network”, which denotes the TWAIN driver 141 used via network connection by IHV native protocol, is set as the default scanner (driver). Accordingly, the present exemplary embodiment can improve the user operability.

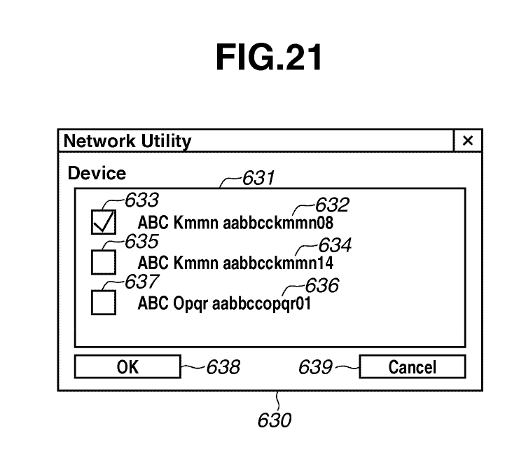

FIG. 21 illustrates an example of a network utility. Referring to FIG. 21, a network utility 630, which is software, periodically executes polling to acquire the status of the device to monitor a push scan event or a status event from the device within the network 4, such as the MFP 3. In the example illustrated in FIG. 21, a main window of the network utility 630 is displayed.

A short cut for launching the network utility 630 is registered in a startup folder as one of programs started while booting the OS. When the OS is booted, the network utility 630 is launched and operates as a resident program. A device display field 631 displays the device monitored by the network utility 630.

Each of device names 632, 634, and 646 denotes a device name of the monitoring target device within the network 4. More specifically, the device name 632 of the MFP 3 includes a MAC address of the MFP 3 “aabbcckmmn08”. The device name 634 corresponds to an MFP having the same model name as that of the MFP 3 and a serial number different from that of the MFP 3. The MFP has a MAC address “aabbcckmmn14”. The device name 636 corresponds to an MFP of ABC Corporation having the model name “Opqr”. The MFP has a MAC address “aabbccopqr01”.

If any of monitoring target device check boxes 633, 635, and 637 has been checked, the network utility 630 monitors the corresponding device. On the other hand, the network utility 630 does not monitor a device whose corresponding monitoring target device check box is not checked.

In the example illustrated in FIG. 21, the network utility 630 monitors the MFP 3, which is displayed as having the device name “ABC Kmmn aabbcckmmn08” only. Referring to FIG. 21, when the user presses an OK button 638, the network utility 630 stores the setting of each of the monitoring target device check boxes 633, 635, and 637. Furthermore, in this case, the network utility 630 closes its main window.

When the user presses a cancel button 639, the main window of the network utility 630 is closed. More specifically, if the user presses the cancel button 639, the network utility 630 does not store the setting of each of the monitoring target device check box 633, 635, and 637. Even after the user has pressed the OK button 638 or the cancel button 639 and thus the main window is closed, the network utility 630 operates as a resident program operating on the PC 1 and continues monitoring the device existing within the network 4.

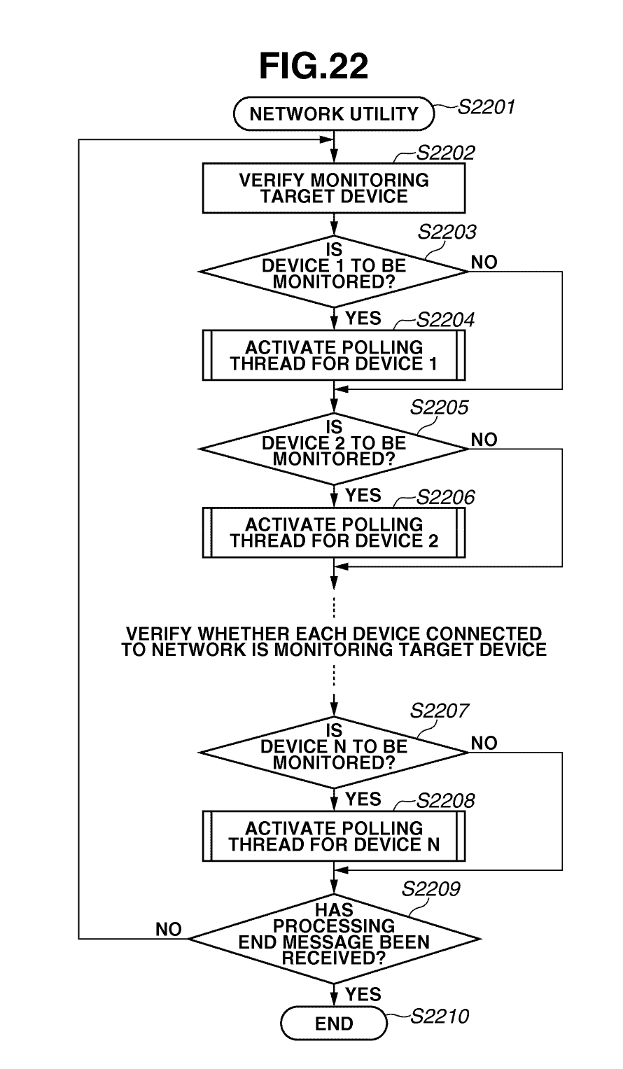

FIG. 22 is a flow chart illustrating an example of processing executed by using the network utility. A program of the processing illustrated in the flow chart of FIG. 22 is implemented by the CPU 204 by loading the program from the HDD 202 on the RAM 201.

When the OS is booted and the function of the shortcut for launching the network utility 630, which is registered in the startup folder, is executed, the processing in the flow chart of FIG. 22 starts. Referring to FIG. 22, in step S2201, the network utility 630 is launched and starts the processing illustrated in FIG. 22.

In step S2202, the network utility 630 confirms the monitoring target device existing within the network 4 according to the setting of each of the monitoring target device check boxes 633, 635, and 637. In step S2203, the network utility 630 determines whether a device 1 (i.e., the device displayed with the device name 632 in the example illustrated in FIG. 21) is a monitoring target device. If it is determined that the device 1 is a monitoring target device (YES in step S2203), then the processing advances to step S2204. On the other hand, if it is determined that the device 1 is not a monitoring target device (NO in step S2203), then the processing advances to step S2205.

In step S2204, the network utility 630 launches a polling thread for the device 1, which is used for monitoring the device 1. In step S2205, the network utility 630 determines whether a device 2 (i.e., a device displayed with the device name 634 in the example illustrated in FIG. 21) is a monitoring target device. If it is determined that the device 2 is a monitoring target device (YES in step S2205), then the processing advances to step S2206. On the other hand, if it is determined that the device 2 is not a monitoring target device (NO in step S2205), then the processing advances to step S2207.

In step S2206, the network utility 630 launches a polling thread for the device 2, which is used for monitoring the device 2. In step S2207, the network utility 630 determines whether a device N (i.e., the device displayed with the device name 636 in the example illustrated in FIG. 21 when N=3) is a monitoring target device. If it is determined that the device N is a monitoring target device (YES in step S2207), then the processing advances to step S2208. On the other hand, if it is determined that the device N is not a monitoring target device (NO in step S2207), then the processing advances to step S2209.

In step S2208, the network utility 630 launches a polling thread for the device N, which is used for monitoring the device N. In step S2209, the network utility 630 determines whether a processing end message has been received from the OS. If it is determined that a processing end message has been received from the OS (YES in step S2209), then the processing advances to step S2210. In step S2210, the network utility 630 ends all the active polling threads for the active devices (the devices 1 through N) and ends the processing illustrated in FIG. 22.

If it is determined that the network utility 630 has not received a processing end message from the OS yet (NO in step S2209), then the processing returns to step S2202. When the network utility 630 launches the polling thread for the device 1 through N in steps S2204, S2206, and S2208, if the device polling thread has already been launched and the device is currently monitored, the network utility 630 does not launch the device polling thread in an overlapped manner.

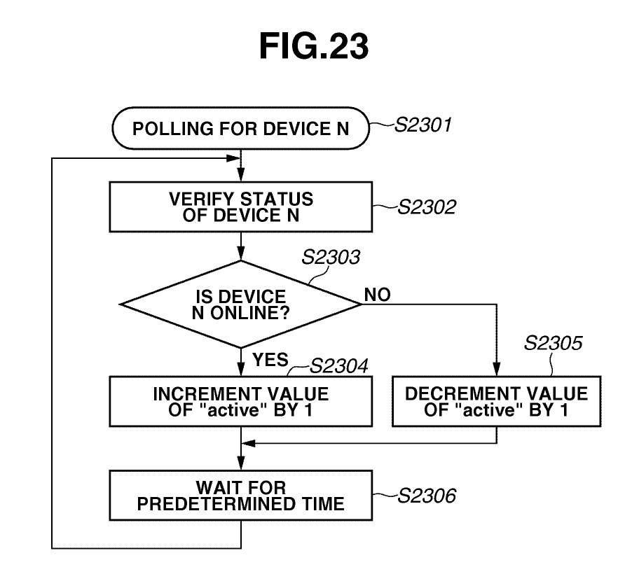

FIG. 23 is a flow chart illustrating an example of processing for polling a device N. The processing illustrated in FIG. 23 is implemented by the CPU 204 by loading and executing a corresponding program from the HDD 202 on the RAM 201.

When the network utility 630 has launched the polling thread for a device N (N is an integer greater than 1) in steps S2204, S2206, and S2208 illustrated in FIG. 22, the processing illustrated in FIG. 23 starts. Referring to FIG. 23, in step S2301, the network utility 630 starts the polling for the device N. In step S2302, the network utility 630 confirms the status of the device N. In step S2303, the network utility 630 determines whether the device N is online. If it is determined that the device N is online (YES in step S2303), then the processing advances to step S2304. On the other hand, if it is determined that the device N is not online (i.e., if it is determined that the device N is offline) (NO in step S2303), then the processing advances to step S2305.

In step S2304, the network utility 630 increments a value of the following registry information about the device N (i.e., the value of the apparatus “active”) by 1 and then the processing advances to step S2306:

HKEY_CURRENT_USER_MACHINE¥Software¥ABC¥Network

Utility¥<Device Name>¥

Name: active
Type: REG_SZ

In step S2305, the network utility 630 decrements the value of the registry information (i.e., the value of the apparatus “active” by 1. Then, the processing advances to step S2306. For the element <Device Name>, the model name of the device N is assigned. More specifically, the model name “Kmmn” is assigned to the element <Device Name> for the devices 1 and 2. On the other hand, the model name “Opqr” is assigned to the element <Device Name> for the device 3.

In step S2306, after the network utility 630 has waited for a predetermined time (in the present exemplary embodiment, the predetermined wait time of five seconds), then the processing returns to step S2302.

As described above, the information that describes the state of each of the devices 1 through N as to whether the device is online (or offline) is assigned to the value of the registry information (the value of the apparatus “active”). In the present exemplary embodiment, as a characteristic point of the present invention, the network utility 630 launches a polling thread for each device and increments or decrements the value of the apparatus “active” by 1 in steps S2304 and S2305.

More specifically, if a plurality of devices having the same model name and different serial numbers exists within the network 4, the network utility 630 is enabled to flawlessly monitor the state of all the monitoring target devices existing within the network 4 by assigning a device name including a MAC address, such as “Kmmn aabbcckmmn08” to the element <Device Name> included in the registry key of the registry information instead of simply assigning the model name.

On the other hand, because the device management and control file 950 includes previously generated static information as illustrated in FIG. 20, it is difficult to describe registry information by using the model name to which a MAC address, which is to be identified from among a vast amount of MAC addresses, is added. In particular, description of the registry information by using the model name including a MAC address becomes difficult when a plurality of devices having the same model name (i.e., the device name such as the device names 632 and 634 displayed in the device display field 631) and different serial numbers exists within the network 4.

In this case, although not entirely flawlessly implemented, the present invention enables substantially correct monitoring of the state of the devices existing within the network 4 by causing the network utility 630 to launch a polling thread for each independent device and increments and decrements the value of the apparatus “active” by 1 in steps S2304 and S2305 in each device polling thread.

Accordingly, in the present exemplary embodiment, the user is enabled to launch the TWAIN application 142 in the state where the device desired to be used is selected as the default scanner (driver) in the scanner selection field 621. Accordingly, the present exemplary embodiment can achieve a high user operability.

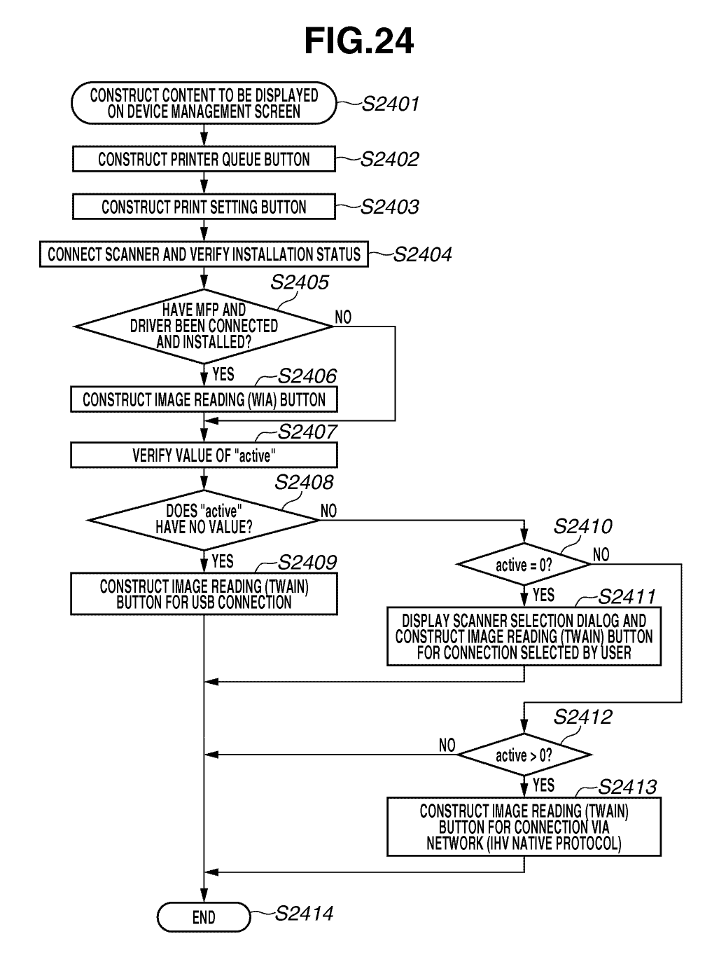

FIG. 24 is a flow chart illustrating an example of processing for constructing a content to be displayed on the device management screen. The processing illustrated in FIG. 24 is implemented by the CPU 204 by loading and executing a corresponding program from the HDD 202 on the RAM 201.

When the processing for constructing the content to be displayed on the device management screen is executed in step S1504 (FIG. 13), the processing illustrated in the flow chart of FIG. 24 starts. Referring to FIG. 24, in step S2401, the device management control unit 902 starts the processing for constructing the content to be displayed on the device management screen. In step S2402, the device management control unit 902 constructs a printer queue button 604 according to the content of the element <dm:name> 805 (FIG. 8) and the element <dm:execute> 806 (FIG. 8). In step S2403, the device management control unit 902 constructs a print setting button 605 according to the content of the element <dm:name> 807 (FIG. 8) and the element <dm:execute> 808 (FIG. 8).

In step S2404, the device management control unit 902 confirms the status of connection of a scanner and the status of installation of the corresponding driver according to the content of the element <dm:device> 811 (FIG. 8) and the element <dm:available> 812 (FIG. 8). If it is determined that the MFP 3 has been connected to the PC 1 via the USB interface 14 and that the IHV WIA driver manufactured by the manufacturer of the device (i.e., ABC Corporation) has been installed (YES in step S2405), then the processing advances to step S2406. Alternatively, if it is determined that the MFP 3 has been connected to the PC 1 via the network 4 by using the WSD connection and that the Standard WIA driver 703, which is included in the OS as a standard function, has been installed (YES in step S2405), then the processing advances to step S2406. In a case different from those described above (NO in step S2405), then the processing advances to step S2407.

In step S2406, the device management control unit 902 constructs a reading (WIA) button 610 according to the content of the element <dm:name> 809 (FIG. 8) and the element <dm:execute> 813 (FIG. 8). The processing in step S2406 is executed in the case where an image can be read by using the IHV WIA driver 704 or the standard WIA driver 703 via USB connection or via the network that uses WSD.

In step S2407, the device management control unit 902 confirms the value of the registry information (i.e., the value of the apparatus “active”) according to the content of the element <dm:keywordInRegistry> 954 (FIG. 20):

HKEY_CURRENT_USER_MACHINE¥Software¥ABC¥Network

Utility¥<Device Name>¥

Name: active
Type: REG_SZ

If it is determined that no value has been set to the apparatus “active” (NO in step S2408), then the processing advances to step S2410. On the other hand, if it is determined that an arbitrary value, such as “0”, “1”, or “2”, has been set (YES in step S2408), then the processing advances to step S2409.

In step S2409, the device management control unit 902 constructs the reading (TWAIN) button 611 for USB connection according to the content of the element <dm:name> 952 (FIG. 20) and the element <dm:execute> 955 (FIG. 20). In step S2414, the processing for constructing the content to be displayed on the device management screen ends. The processing in step S2409 is executed in the case where an image can be read by using the TWAIN driver 141 via USB connection.

In step S2410, the device management control unit 902 determines whether the value of “active” is “0”. If it is determined that the value of “active” is “0” (YES in step S2410), then the processing advances to step S2411. On the other hand, if it is determined that the value of “active” is not “0” (NO in step S2410), then the processing advances to step S2412.

In step S2411, the device management control unit 902 displays the scanner selection dialog 625 (FIG. 6D) according to the content of the element <dm:name> 957 (FIG. 20) and the element <dm:execute> 960 (FIG. 20). Furthermore, the device management control unit 902 constructs the reading (TWAIN) button 611 for the connection method selected by the user. Then, the processing advances to step S2414. In step S2414, the processing for constructing the content to be displayed on the device management screen ends.

The processing in step S2411 is executed in the case where an image cannot be read by the TWAIN driver 141 via USB connection. More specifically, in this case, the connection between the PC 1 and the MFP 3 is implemented not via the USB interface 14 or the network 4.

In this case, it is useful if the TWAIN application 142 is launched in a state where the TWAIN application 142 has at first displayed the scanner selection dialog 625 (FIG. 6D) and where the TWAIN driver selected by the user is set in the scanner selection field 621. Accordingly, the device management control unit 902 constructs the reading (TWAIN) button 611, which is a button for displaying the scanner selection dialog 625 (FIG. 6D).

In step S2412, the device management control unit 902 determines whether the value of “active” is greater than “0”. If it is determined that the value of “active” is greater than “0” (YES in step S2412), then the processing advances to step S2413. If it is determined that the value of “active” is not greater than “0” (NO in step S2412), then the processing advances to step S2414. In step S2414, the processing for constructing the content to be displayed on the device management screen ends.

In step S2413, the device management control unit 902 constructs the reading (TWAIN) button 611 for network connection by IHV native protocol according to the element <dm:name> 962 (FIG. 20) and the element <dm:execute> 965 (FIG. 20). Then, the processing advances to step S2414. In step S2414, the processing for constructing the content to be displayed on the device management screen ends. The processing instep S2413 is executed in the case where an image can be read by the TWAIN driver 141 via network connection by IHV native protocol.

With the above-described configuration, the present exemplary embodiment can implement a peripheral apparatus control system configured to provide the function of the device appropriate in the environment of use by the user by utilizing the registry information set by the network utility 630 even if an MFP that does not include an external storage device and includes a printer and a scanner only, an MFP that does not include a printer and includes a scanner, a facsimile apparatus, and an external storage device only, or a single-function color scanner that does not include functions of a printer and an external storage device, is used as an example of the peripheral apparatus.

In the third exemplary embodiment described above, an MFP that does not include an external storage device and includes a printer and a scanner only, an MFP that does not include a printer and includes a scanner, a facsimile apparatus, and an external storage device only, or a single-function color scanner that does not include functions of a printer and an external storage device, is used as an example of the peripheral apparatus. In addition, the third exemplary embodiment is capable of providing the function of a device appropriate in the environment of use by the user by utilizing the registry information set by the network utility 630.

In a fourth exemplary embodiment of the present invention, the above-described purpose of the present invention is achieved by executing a method for automatically identifying a device desired to be used by the user.

More specifically, in the present exemplary embodiment, in a case where an image can be read by the TWAIN driver, the following element <dm:function> is described in the device management and control file:

<dm:function>
<! -- Case where Image can Be Read by TWAIN Driver -->
<dm:name xml:lang=“en-US”>Image Scan (TWAIN) </dm:name>
<dm:execute>TWAINScan.exe “ABC Kmmn (TWAIN)” /devmng

</dm:execute>

</dm:function>

In the present exemplary embodiment, the TWAIN application 142 generates a list of TWAIN drivers (scanners) that includes a text string as the TWAIN driver name, based on which the model name of the TWAIN driver (scanner) “ABC Kmmn (TWAIN)”, which is the first argument, can be identified, from among all the installed TWAIN drivers (scanners). In addition, the TWAIN application 142 selects an appropriate TWAIN driver (scanner) from among the TWAIN drivers (scanners). Furthermore, the TWAIN application 142 sets the selected TWAIN driver (scanner) in the scanner selection field 621 and launches the set TWAIN driver (scanner).

For a method executed by the TWAIN application 142 for selecting an appropriate TWAIN driver (scanner) from among the TWAIN drivers (scanners) included in the generated list, it is useful if the TWAIN application 142 executes a communication test on each TWAIN driver (scanner) and selects a TWAIN driver (scanner) available for normal communication. If no TWAIN driver (scanner) available for normal communication has been extracted, the TWAIN application 142 displays the scanner selection dialog 625 to allow the user to select a TWAIN driver (scanner).

If a plurality of TWAIN drivers (scanners) available for normal communication has been extracted, it is useful if the TWAIN application 142 prioritizes the communication speed, generates the priority order in order of USB connection and network connection by IHV native protocol, and selects a TWAIN driver (scanner) having a high priority order.

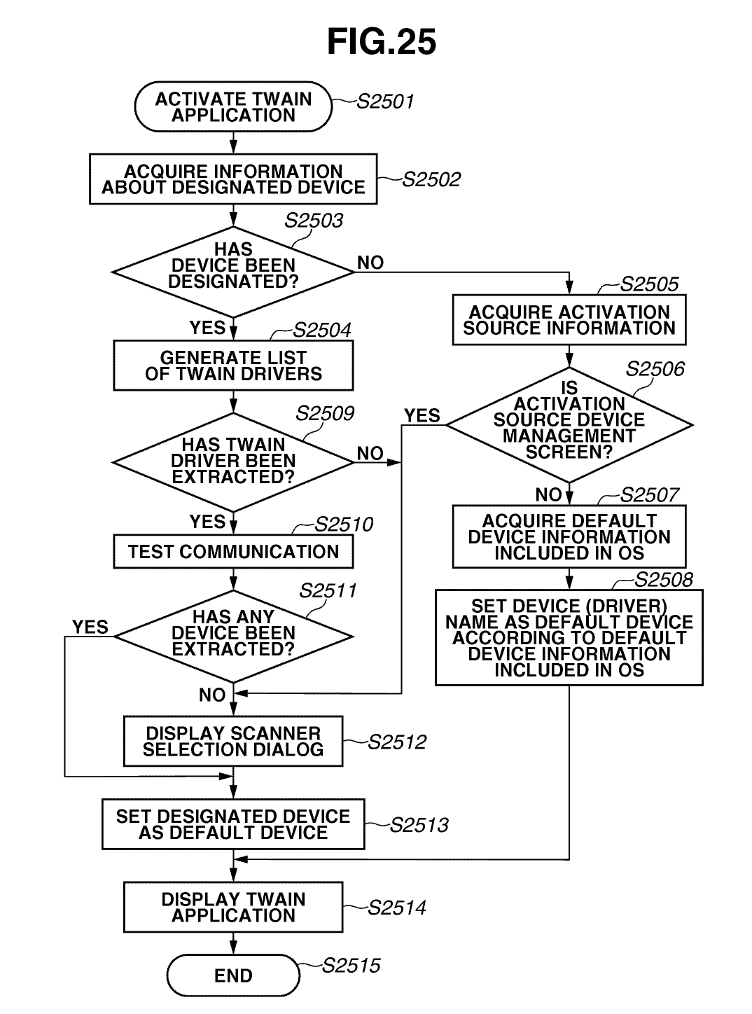

Processing according to the present exemplary embodiment will be described in detail below with reference to FIG. 25. FIG. 25 is a flow chart illustrating an example of processing for launching a TWAIN application. A program of the processing illustrated in the flow chart of FIG. 25 is implemented by the CPU 204 by loading the program from the HDD 202 on the RAM 201.

Referring to FIG. 25, in step S2501, when the user presses (designates) the reading (TWAIN) button 611 via the device management screen 600, the processing for launching the TWAIN application 142 starts. More specifically, in step S2501, the device management and control unit 902 included in the device management application 80 (FIG. 10) transfers information included in the element “<dm:execute>TWAINScan.exe “ABCKmmn (TWAIN)”/devmng </dm:execute>” to the application control unit 907 via the link execution unit 903.

In step S2502, the application control unit 907 acquires device designation information, which is described by using the TWAIN driver name that is the first argument, from the information transferred in step S2501. In step S2503, the application control unit 907 determines whether a TWAIN driver name that is the first argument (i.e., device designation information) is present.

If it is determined that a device has been designated (i.e., if it is determined that device designation information is present) (YES in step S2503), then the processing advances to step S2504. On the other hand, if it is determined that no device has been designated (i.e., if it is determined that no device designation information is present) (NO in step S2503), then the processing advances to step S2505.

In the present exemplary embodiment, a device is designated based on the TWAIN driver name that is the first argument, which is included in the element “<dm:execute>TWAINScan.exe “ABCKmmn (TWAIN)”/devmng </dm:execute>”. Accordingly, in this case, the processing advances from step S2503 to step S2504. On the other hand, if the TWAIN application 142 is launched without setting a first argument (NO in step S2503), then the processing advances from step S2503 to step S2505.

In step S2504, based on a text string according to which the model name of the TWAIN driver “ABC Kmmn (TWAIN)” (or the scanner corresponding to the TWAIN driver) that is the first argument can be identified, the application control unit 907 searches for a TWAIN driver having a TWAIN driver name including the above-described text string from among all the installed TWAIN drivers. In addition, in step S2504, the application control unit 907 generates a list of TWAIN drivers that satisfy the above-described search condition.

If no TWAIN driver that satisfies the above-described search condition is extracted, the application control unit 907 generates a list including no TWAIN driver (i.e., a list including a null value). In step S2509, the application control unit 907 refers to the content of the list and determines whether any TWAIN driver has been extracted. If it is determined that any TWAIN driver has been extracted (YES in step S2509), then the processing advances to step S2510. On the other hand, if it is determined that no TWAIN driver has been extracted (NO in step S2509), then the processing advances to step S2512.

In step S2510, the application control unit 907 transmits a predetermined message to each scanner corresponding to each TWAIN driver. Furthermore, the application control unit 907 executes a communication test based on the content of a reply transmitted from each TWAIN driver. Furthermore, the application control unit 907 selects a TWAIN driver available for normal communication.

If a plurality of scanners available for normal communication has been extracted, then the application control unit 907 sets a priority order in order of USB connection and a connection via network by IHV native protocol in descending order of communication speed. In addition, the application control unit 907 selects a scanner (or a TWAIN driver corresponding to a scanner) having a high priority order.

In step S2511, the application control unit 907 searches for a device (scanner) available for normal communication. If the device (scanner) available for normal communication has been selected, the application control unit 907 sets the scanner (the TWAIN driver) designated based on the TWAIN driver name for the selected device (scanner) as the first argument. Then, the processing advances to step S2513.

On the other hand, if no device (scanner) available for normal communication has been extracted and if no device (scanner) has been selected (NO in step S2511), then the processing advances to step S2512. In step S2512, the application control unit 907 displays the scanner selection dialog 625 illustrated in FIG. 6D. More specifically, when the user selects a TWAIN driver via the scanner selection field 626 and presses the OK button 627, the application control unit 907 sets the scanner (TWAIN driver) designated based on the selected TWAIN driver name as the first argument. Then the processing advances to step S2513. In step S2513, the default device setting unit 908 sets the designated device (i.e., the scanner designated by using the TWAIN driver name) as the default device for the TWAIN application 142. Then, the processing advances to step S2514.

In step S2505, the application control unit 907 transfers the information received from the device management and control unit 902 via the link execution unit 903 in step S2501 to the launching source determination unit 906. The information refers to the information described in the element “<dm:execute>TWAINScan.exe/devmng</dm:execute>”, for which no first argument has been set designated.

The launching source determination unit 906 acquires a launching source that is a second argument. In step S2506, the launching source determination unit 906 determines whether the launching source is the device management screen or a source other than the device management screen. If it is determined that the launching source is the device management screen (i.e., the device management screen 600 in the present exemplary embodiment) (YES in step S2506), then the processing advances to step S2512. On the other hand, if it is determined that the launching source is a source other than the device management screen (NO in step S2506), then the processing advances to step S2507.

In the present exemplary embodiment, based on the second argument “/devmng” included in the element <dm:execute>TWAINScan.exe/devmng</dm:execute>, the device management screen 600 is designated as the launching source. Accordingly, in this case, the processing advances from step S2506 to step S2512. On the other hand, if the TWAIN application 142 has been launched from a source other than the device management screen 600 (NO in step S2506), the second argument “/other” has been designated as the launching source. Accordingly, the processing advances from step S2506 to step S2507.

In step S2507, the default device setting unit 908 acquires information about the default device for the OS via the application/DDI interface 84. In the present exemplary embodiment, a “default device for the OS” refers to a device to which a default mark 502 has been assigned in the folder 500 (FIG. 5A). Furthermore, in the present exemplary embodiment, because the device 501 (XYZ Defg) has been set as the default device, the default device setting unit 908 acquires the device N “XYZ Defg” in step S2507.

In step S2508, the default device setting unit 908 sets the device (driver) name as the device name of the default device for the TWAIN application 142 based on the default device for the OS acquired in step S2507. Then, the processing advances to step S2514. If the default device setting unit 908 does not extract an appropriate device (driver) name by referring to the default device for the OS acquired in step S2507, then the default device setting unit 908 executes the following processing. More specifically, the default device setting unit 908 sets the device (driver) name, which has been set when the TWAIN application 142 has been launched the last time as the default device.

In step S2514, the application control unit 907 displays the TWAIN application 142. In step S2515, the processing for launching the TWAIN application ends. At this timing, the launched TWAIN application 142 is currently displayed in a state where the default device set in step S2513 or S2508 has been selected.

Furthermore, in the present exemplary embodiment, information about the default device for the TWAIN application 142 is stored on a memory area of 201, which is managed by the TWAIN application 142.

As described above, in the present exemplary embodiment, an element <dm:execute> for launching the TWAIN application 142 is described and included in the device management and control file by using a text string which enables specification of the model name of the TWAIN driver (scanner) as an argument. In addition, in the present exemplary embodiment, the TWAIN application 142 selects and launches an appropriate TWAIN driver (scanner) based on the text string as described above. With the above-described configuration, the present exemplary embodiment can implement a peripheral apparatus control system configured to provide the function of a device appropriate in the environment of use by the user.

The present invention can also be implemented by executing processing according to a fifth exemplary embodiment of the present invention. More specifically, the present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In each of the exemplary embodiments of the present invention described above, the device management application 80 illustrated in FIG. 10 is used as an example of the application. However, the present invention is not limited to this. More specifically, an aspect of the present invention can be effectively implemented by an arbitrary application having a function similar to the function of each exemplary embodiment of the present invention.

In each exemplary embodiment of the present invention described above, the TWAIN application 142 illustrated in FIGS. 6B and 10 is used as an example of the application. However, the present invention is not limited to this. More specifically, the present invention can also be effectively implemented by an arbitrary application having a function similar to the function of the above-described exemplary embodiment of the present invention, such as an application for printing an image (document image).

In addition, in each of the exemplary embodiments of the present invention described above, a PC is used as an example of the information processing apparatus. However, the present invention is not limited to this. More specifically, an arbitrarily selected information processing apparatus (terminal), which can be used in a manner similar to the manner described above, such as a digital versatile disc (DVD) player, a gaming machine, a set-top box, or an Internet appliances, can also effectively implement the present invention.

Furthermore, in each of the exemplary embodiments of the present invention described above, an MFP is used as an example of the peripheral apparatus. However, the present invention is not limited to this. More specifically, the present invention can be effectively implemented by using any of a copying machine, a facsimile apparatus, a scanner, or a digital camera or an apparatus having a plurality of functions including a combination of the functions of the above-described apparatuses as the peripheral apparatus.

Moreover, in each exemplary embodiment of the present invention, an OS equivalent to Windows® 7 is used as an example of the OS. However, the present invention is not limited to this. More specifically, an arbitrary OS can be used to implement an aspect of the present invention.

In addition, in each exemplary embodiment of the present invention, Ethernet is used as an example of the configuration of the network 4. However, the present invention is not limited to this. More specifically, another arbitrary network having a different configuration can be employed to implement an aspect of the present invention.

Furthermore, in each exemplary embodiment of the present invention, Ethernet is used as an example of the interface between the PC 1, and the MFPs 3 and 7. However, the present invention is not limited to this. More specifically, it is also useful if a different other arbitrary interface is used to implement an aspect of the present invention, such as a wireless LAN, Institute of Electrical and Electronic Engineers (IEEE) 1394, Bluetooth, or USB.

In addition, in each of the exemplary embodiments of the present invention described above, WSD is used as an example of the protocol used for the web service. However, the present invention is not limited to this. More specifically, a different other arbitrary protocol, such as a protocol unique to an IHV, can be used to effectively implement an aspect of the present invention.

Furthermore, in each exemplary embodiment of the present invention, when the user presses the reading (TWAIN) button 611 via the device management screen 600, the TWAIN application 142 is launched in a state where an appropriate device (driver) has been set. However, the present invention is not limited to this. More specifically, it is also useful if an appropriate device (driver) name is designated and an arbitrary application is executed by launching the arbitrary application via the device management screen, which includes a link to a specific web site, to provide a service there.

With the above-described configuration, each exemplary embodiment of the present invention can provide a device management screen capable of providing an appropriate display and function according to the environment of use of the user. In addition, according to each exemplary embodiment of the present invention having the above-described configuration, when the user launches an a plurality of to utilize a function provided by the peripheral apparatus, the user is allowed to appropriately and securely utilize the function provided by the peripheral apparatus because the display and the function of the application is automatically caused to become optimum according to the environment of use of the user.

Therefore, with the above-described configuration, each exemplary embodiment of the present invention can provide the user with an appropriate function of the device according to the environment of use of the user.

Furthermore, the present invention is not limited to a specific exemplary embodiment described above. More specifically, the present invention can be arbitrarily modified or altered within the scope of the present invention described in claims thereof.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-201853 filed Sep. 1, 2009, and No. 2009-285354 filed Dec. 16, 2009, which are hereby incorporated by reference herein in their entirety.

What is claimed is:

1. An apparatus comprising:
a management unit configured to manage a device that provides a plurality of functions; and
a utilization unit configured to utilize one function among the plurality of functions,
wherein the management unit is configured to confirm whether a function different from the one function, among the plurality of functions, is available according to management and control data that includes information for constructing a management screen, which manages the device and configured to set an argument to an object indicating a link to the utilization unit according to a result of the confirmation, and
wherein the utilization unit is configured, if the object, which is displayed on the management screen, is designated, to set the device according to the argument.

2. The apparatus according to claim 1, wherein the utilization unit is configured to utilize a scanner function as the one function, and
wherein the management unit is configured to confirm whether a storage function is available as another function, among the plurality of functions, according to the management and control data.

3. The apparatus according to claim 1, wherein the utilization unit is configured to utilize a scanner function as the one function, and
wherein the management unit is configured to confirm whether a printer function is available as another function, among the plurality of functions, is available according to the management and control data.

4. The apparatus according to claim 3, wherein the management unit is configured to confirm whether the printer function is available according to an interface for connecting the apparatus to the device.

5. The information processing apparatus according to claim 1, wherein the management unit is configured to set an argument including a device name to the object indicating the link to the utilization unit and to construct the object according to a result of the confirmation.

6. The apparatus according to claim 1, wherein the utilization unit is configured, if the object is designated, to determine whether the device identified based on the argument is an unknown device according to the argument and if the device is an unknown device, the utilization unit is configured to display a dialog for selecting a device while if the device is not an unknown device, the utilization unit is configured to set a device according to the argument.

7. An apparatus comprising:
an assignment unit configured to confirm a status of a target device and assign information about the status to a value of status information about the target device according to a result of the confirmation;
a management unit configured to manage a device; and
a utilization unit configured to utilize a function provided by the device,
wherein the management unit is configured to confirm the value of the status information according to the status information described in management and control data, which is used for constructing a management screen for managing the device, and configured to set an argument to an object indicating a link to the utilization unit according to a result of the confirmation, and
wherein the utilization unit is configured, if the object, which is displayed on the management screen, is designated, to set a device according to the argument.

8. The apparatus according to claim 7, wherein the value of the status information is assigned by launching a polling thread, which is used for determining whether each device is online, and if the device is online, by incrementing the value of the status information by 1 while if the device is not online, by decrementing the value of the status information by 1.

9. An apparatus comprising:
a management unit configured to manage a device; and
a utilization unit configured to utilize a function provided by the device,
wherein the management unit is configured to set a model name of a driver of the device that provides a plurality of functions, which is described in management and control data, which is used for constructing a management screen used for managing the device, to an object indicating a link to the utilization unit as an argument, and
wherein the utilization unit is configured, if the object, which is displayed on the management screen, is designated, to select a driver of the device based on the model name that is the argument and to set a device according to the driver of a selected device.

10. The apparatus according to claim 9, wherein the utilization unit is configured to search for a driver including the model name that is the argument as a driver name from among installed drivers according to the argument, configured, if a plurality of drivers exists as a result of the search, to execute a communication test on the device corresponding to each driver, configured to select a driver of each device according to a result of the communication test, and configured to set the device according to the selected driver.

11. The apparatus according to claim 10, wherein the utilization unit is configured, if a plurality of devices available for communication exists as a result of the communication test, to select a driver of the device according to a communication speed, and configured to set a device according to the selected driver.

12. A method executed by an apparatus including a management unit configured to manage a device that provides a plurality of functions, and a utilization unit configured to utilize one function among the plurality of functions, the method comprising:
setting an argument to an object indicating a link to the utilization unit according to a result of a confirmation as to whether a function different from the one function, among the plurality of functions, is available according to management and control data that includes information for constructing a management screen, which management screen being a screen configured to manage the device, and
setting the device according to the argument if the object, which is displayed on the device management screen, is designated.

13. A method executed by an apparatus including an assignment unit, a management unit configured to manage a target device and a utilization unit configured to utilize a function provided by the device, the method comprising:
confirming a status of the target device and assigning information about the status to a value of status information about the target device according to a result of the confirmation;
confirming the value according to the status information described in management and control data, which is used for constructing a management screen for managing the device, and setting an argument to an object indicating a link to the utilization unit according to a result of the confirmation, and
setting a device according to the argument if the object, which is displayed on the management screen, is designated.

14. A method executed by an apparatus including a management unit configured to manage a device, and a utilization unit configured to utilize a function provided by the device, the method comprising:
setting a model name of a driver of the device that provides a plurality of functions, which is described in management and control data, which is used for constructing a management screen used for managing the device, to an object indicating a link to the utilization unit as an argument, and
selecting a driver of the device based on the model name that is the argument and setting a device according to the driver of a selected device if the object, which is displayed on the management screen, is designated.

15. Computer-executable instructions which, when executed by a computer, cause the computer to function as a management unit configured to manage a device that provides a plurality of functions and as a utilization unit configured to utilize one function among the plurality of functions, the instructions causing the computer to perform operations comprising:
setting an argument to an object indicating a link to the utilization unit according to a result of a confirmation as to whether a function different from the one function, among the plurality of functions, is available according to management and control data that includes information for constructing a management screen, which management screen being a screen configured to manage the device, and
setting the device according to the argument if the object, which is displayed on the management screen, is designated.

16. Computer-executable instructions which, when executed by a computer, cause the computer to function as an assignment unit configured to confirm a status of a target device and assign information about the status to a value of status information about the target device according to a result of the confirmation, as a management unit configured to manage the device, and as a utilization unit configured to utilize a function, the instructions causing the computer to perform operations comprising:
confirming a status of the target device and assigning information about the status to a value of status information about the target device according to a result of the confirmation;
confirming the value according to the status information described in management and control data, which is used for constructing a management screen for managing the device, and setting an argument to an object indicating a link to the utilization unit according to a result of the confirmation, and
setting a device according to the argument if the object, which is displayed on the device management screen, is designated.

17. Computer-executable instructions which, when executed by a computer, cause the computer to function as a management unit configured to manage a device, and a utilization unit configured to utilize a function provided by the device, the instructions causing the computer to perform operations comprising:
setting a model name of a driver of the device that provides a plurality of functions, which is described in management and control data, which is used for constructing a management screen used for managing the device, to an object indicating a link to the utilization unit as an argument, and
selecting a driver of the device based on the model name that is the argument and setting a device according to the driver of a selected device if the object, which is displayed on the device management screen, is designated.

18. The apparatus according to claim 7, wherein the status information is stored in a registry.

19. The method according to claim 13, wherein the status information is stored in a registry.
